(19) United States
(12) Patent Application Publication
(10) Pub. No.: US 2016/0168357 A1
(43) Pub. Date: Jun. 16, 2016

(54) Poly(Arylene Sulfide) Compositions and Processes of Producing Same

(71) Applicant: Chevron Phillips Chemical Company LP, The Woodlands, TX (US)

(72) Inventors: Justin W. Kamplain, Bartlesville, OK (US); David A. Soules, Bartlesville, OK (US)

(21) Appl. No.: 14/565,967

(22) Filed: Dec. 10, 2014

(51) Int. Cl. C08K 5/45; B29C 45/72; B29C 45/00; C08K 3/22; C08K 3/34

(52) U.S. Cl. CPC C08K 5/45; C08K 3/22; C08K 3/346; C08K 3/34; B29C 45/0001; B29C 45/72; C08K 2003/2241; B29K 2081/04

(57) ABSTRACT

A poly(arylene sulfide) polymer composition comprising a neat poly(arylene sulfide) polymer and a cyclic oligomer nucleating agent, wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition, and wherein the poly(arylene sulfide) polymer composition is characterized by a melt crystallization temperature (Tmc) that is greater by at least about 5° C. than a Tmc of the neat poly(arylene sulfide) polymer.

### TECHNICAL FIELD

The present disclosure relates to polymer compositions, more specifically poly(arylene sulfide) polymer compositions, and processes of producing same.

### BACKGROUND

Polymers, such as poly(arylene sulfide) polymers and their derivatives, are used for the production of a wide variety of articles. Generally, the process for producing a particular polymer and any steps thereof can drive the cost of such particular polymer, and consequently influences the economics of polymer articles. Thus, there is an ongoing need to develop and/or improve poly(arylene sulfide) polymer compositions and processes for producing these polymers.

### BRIEF SUMMARY

Disclosed herein is a poly(arylene sulfide) polymer composition comprising a neat poly(arylene sulfide) polymer and a cyclic oligomer nucleating agent, wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition, and wherein the poly(arylene sulfide) polymer composition is characterized by a melt crystallization temperature (Tmc) that is greater by at least about 5° C. than a Tmc of the neat poly(arylene sulfide) polymer.

Also disclosed herein is a process for producing a poly(arylene sulfide) polymer composition comprising (a) reacting a sulfur source and a dihaloaromatic compound in the presence of a polar organic compound to form a poly(arylene sulfide) reaction mixture, (b) washing at least a portion of the poly(arylene sulfide) reaction mixture with a polar organic compound solvent mixture and/or water to obtain a poly(arylene sulfide) polymer composition and a first slurry, wherein the polar organic compound solvent mixture has a temperature of from about 25° C. to about 275° C., and wherein the polar organic compound is present in the polar organic compound solvent mixture in an amount of from about 100 vol. % to about 25 vol. %, based on the total volume of the polar organic compound solvent mixture, (c) optionally treating at least a portion of the poly(arylene sulfide) polymer composition with an aqueous acid solution and/or an aqueous metal cation solution to obtain a treated poly(arylene sulfide) polymer composition, and (d) drying at least a portion of the poly(arylene sulfide) polymer composition and/or treated poly(arylene sulfide) polymer composition to obtain a dried poly(arylene sulfide) polymer composition, wherein the poly(arylene sulfide) polymer composition comprises a poly(arylene sulfide) polymer and a cyclic oligomer nucleating agent, and wherein the poly(arylene sulfide) polymer composition comprises the cyclic oligomer nucleating agent in an amount of from about 2,500 ppmw to about 13,000 ppmw, based on the total weight of the poly(arylene sulfide) polymer composition.

Further disclosed herein is a process of producing a poly(arylene sulfide) polymer article comprising (i) melting a poly(arylene sulfide) polymer composition to yield a molten poly(arylene sulfide) polymer composition, wherein the poly(arylene sulfide) polymer composition comprises a neat poly(arylene sulfide) polymer and a cyclic oligomer nucleating agent, and wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition, and (ii) injection molding the molten poly(arylene sulfide) polymer composition to yield the poly(arylene sulfide) polymer article, wherein a cycle time of injection molding the poly(arylene sulfide) polymer composition is reduced by at least about 5% when compared to a cycle time of injection molding the neat poly(arylene sulfide) polymer.

### BRIEF DESCRIPTION OF THE DRAWINGS

For a detailed description of the preferred embodiments of the disclosed polymer compositions and processes of producing same, reference will now be made to the accompanying drawings in which:

FIG. 1 displays a process flow diagram of an embodiment of a process for production of a poly(phenylene sulfide) (PPS) polymer composition, wherein a cyclic oligomer nucleating agent can be contacted with a neat PPS polymer to yield the PPS polymer composition;

FIG. 2 displays a process flow diagram of an embodiment of a process for production of a master batch comprising a cyclic oligomer nucleating agent, wherein a cyclic oligomer nucleating agent can be contacted with a neat PPS polymer to yield the master batch comprising the cyclic oligomer nucleating agent;

FIG. 3 displays a process flow diagram of an embodiment of a process for production of a PPS polymer composition;

FIG. 4 displays a graph of a gel permeation chromatography trace for a cyclic oligomer nucleating agent; and

FIG. 5 displays a graph of melt crystallization temperature (Tmc) variation with the amount of cyclic oligomer nucleating agent.

### DETAILED DESCRIPTION

Disclosed herein are poly(arylene sulfide) polymer compositions and processes of producing same. In an embodiment, a poly(arylene sulfide) polymer composition can comprise a poly(arylene sulfide) polymer (e.g., a neat poly(arylene sulfide) polymer). The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, poly(phenylene sulfide) polymer (or simply, poly(phenylene sulfide)), also referred to as PPS polymer (or simply, PPS).

In an embodiment, a poly(arylene sulfide) polymer composition can comprise a neat poly(arylene sulfide) polymer and a cyclic oligomer nucleating agent; wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and wherein the poly(arylene sulfide) polymer composition is characterized by a melt crystallization temperature (Tmc) that is greater by at least about 5° C. than a Tmc of the neat poly(arylene sulfide) polymer. In an embodiment, the cyclic oligomer nucleating agent can be a by-product of a poly(arylene sulfide) polymerization reaction. In an embodiment, the cyclic oligomer nucleating agent can be characterized by a weight average molecular weight of from about 400 kg/mol to about 1,500 kg/mol.

In an embodiment, a process of the present disclosure can comprise combining a cyclic oligomer nucleating agent with a neat poly(arylene sulfide) polymer to yield a poly(arylene sulfide) polymer composition, wherein the poly(arylene sulfide) polymer composition is characterized by a Tmc that is greater by at least about 5° C. than a Tmc of the neat poly(arylene sulfide) polymer. While the present disclosure will be discussed in detail in the context of a process for producing a poly(arylene sulfide) polymer, it should be understood that such process or any steps thereof can be applied in a process for producing any other suitable polymer. The polymer can comprise any polymer compatible with the disclosed methods and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed. (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

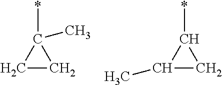

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

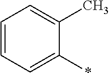 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric material comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

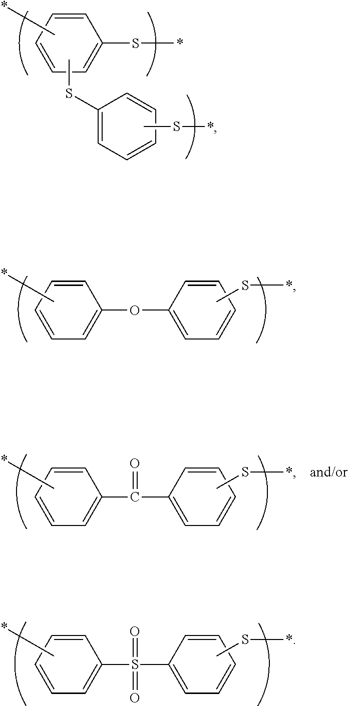

In an embodiment, the arylene sulfide unit can be represented by Formula I.

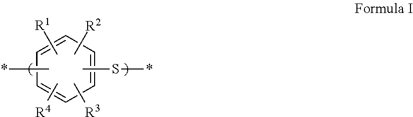

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

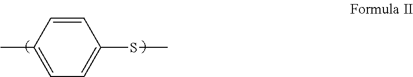

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfone groups, or groups having the following structures:

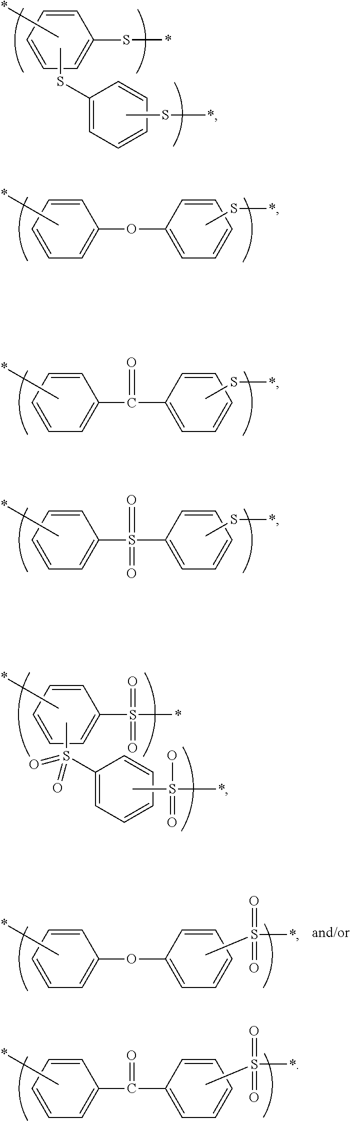

In other embodiments, PPS can comprise up to about 30, 20, 10, or 5 mole percent of units having one or more of the following structures:

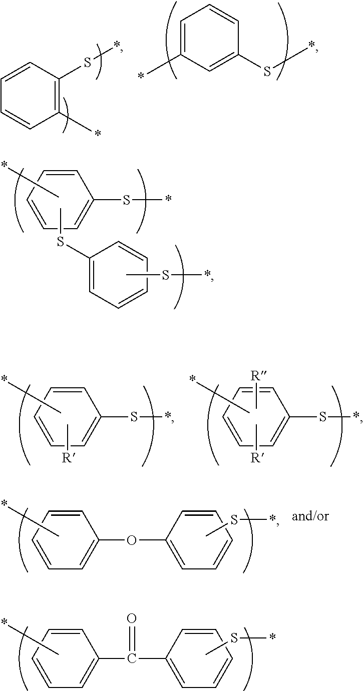

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

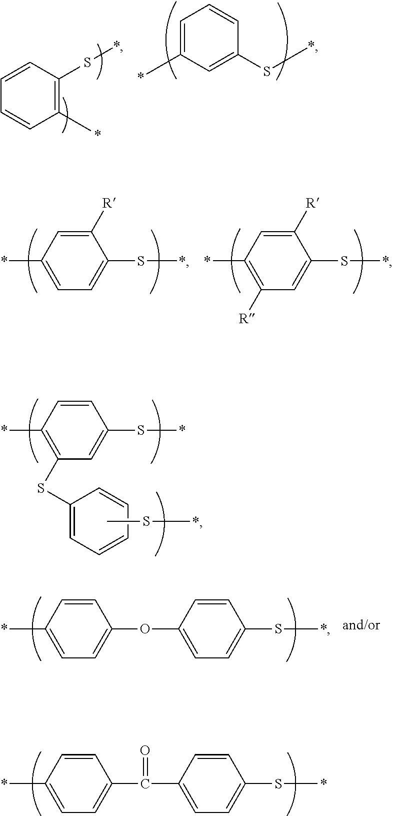

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

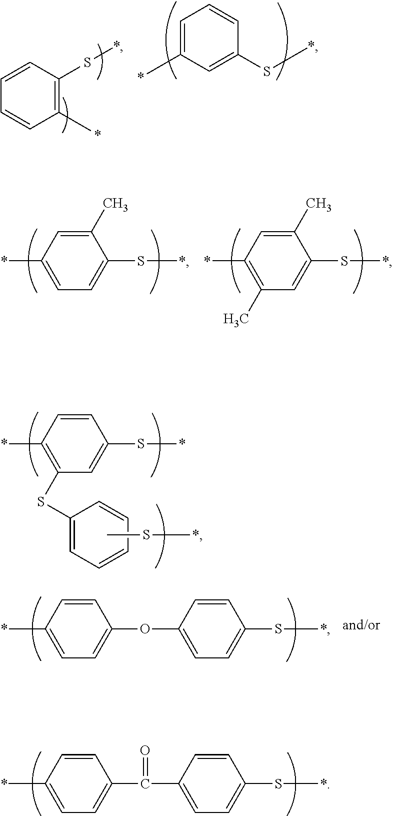

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS cannot typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an embodiment, the process for producing a poly(arylene sulfide) polymer can comprise a step of polymerizing reactants in a reaction vessel or reactor to produce a poly(arylene sulfide) reaction mixture.

In an embodiment, the step of polymerizing reactants comprises reacting a sulfur source and a dihaloaromatic compound (e.g., a polymerization reaction) in the presence of a polar organic compound to form a reaction mixture (e.g., a polymerization reaction mixture).

In an embodiment, the process for producing a poly(arylene sulfide) polymer comprises reacting a sulfur source and a dihaloaromatic compound in the presence of a polar organic compound to form a reaction mixture (e.g., a poly(arylene sulfide) reaction mixture). In an embodiment, the process for producing a poly(arylene sulfide) polymer comprises polymerizing reactants (e.g., a sulfur source and a dihaloaromatic compound) in a reaction vessel or reactor, to produce a reaction mixture (e.g., a poly(arylene sulfide) reaction mixture), wherein at least a portion of the reactants undergo a polymerization reaction.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens (e.g., dihaloaromatic compounds) which can be employed to produce the poly(arylene sulfide) can be represented by Formula III.

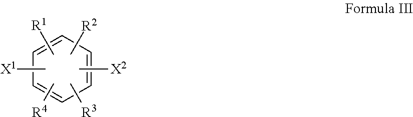

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³ and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O⇄NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O⇄CH₃NHCH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N′-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

Generally, the ratio of reactants employed in the polymerization process to produce a poly(arylene sulfide) can vary widely. However, the typical equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound (e.g., trihaloaromatic compound) optionally employed as a reactant can be any amount to achieve a desired degree of branching to give a desired poly(arylene sulfide) melt flow. Generally, up to about 0.02 mole of polyhalo-substituted aromatic compound per mole of halogenated aromatic compound having two halogens can be employed. As will be appreciated by one of skill in the art, and with the help of this disclosure, generally, the flow properties of a polymer (e.g., melt flow, flow rate, etc.) correlate with the degree of branching (e.g., the use of a polyhalo-substituted aromatic compound could cause branching and lower the flow rate). If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure. As will be appreciated by one of skill in the art and with the help of this disclosure, a “termination process” refers to a process by which a polymerization reaction (e.g., a polymerization reaction yielding a poly(arylene sulfide) polymer) is terminated (e.g., stopped, ceased, finished, concluded, ended, completed, finalized, etc.). Further, as will be appreciated by one of skill in the art and with the help of this disclosure, a polymerization reaction can be considered “terminated” when polymerization is substantially complete or when further reaction would not result in a significant increase in polymer molecular weight.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 mole of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure can be in the range of from about 0 psig to about 400 psig; alternatively, in the range of from about 30 psig to about 300 psig; or alternatively, in the range of from about 100 psig to about 250 psig.

The polymerization can be terminated (e.g., quenched) by cooling the reaction mixture (removing heat) to a temperature below that at which substantial polymerization takes place. In some instances the cooling of the reaction mixture can also begin the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

In some embodiments, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid (e.g., a quench liquid) comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. A process for preparing poly(arylene sulfide) which utilizes the addition of water, polar organic compound, and/or other solvent(s) to terminate the reaction can be referred to as a quench termination process. The cooling of the reaction mixture can be facilitated by the use of reactor jackets or coils. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

In an embodiment, the process for producing a poly(arylene sulfide) polymer is a quench process comprising a quench step. In an embodiment, the quench step comprises quenching the reaction mixture (e.g., quenching the polymerization reaction) with a quench liquid, wherein the quench liquid can comprise water, a polar organic compound, or combinations thereof.

In an embodiment, a process for producing a poly(arylene sulfide) polymer can comprise quenching the reaction mixture by adding a quench liquid thereto. As will be appreciated by one of skill in the art and with the help of this disclosure, a reaction cycle ends or a quench cycle begins when polymerization is substantially complete or when further reaction would not result in a significant increase in polymer molecular weight. For example, in a quench step, a quench liquid can be added to the poly(arylene sulfide) reaction mixture and a temperature of the poly(arylene sulfide) reaction mixture can be lowered, thereby causing the polymer to precipitate out the solution (e.g., no further significant increase in polymer molecular weight). Further, as will be appreciated by one of skill in the art and with the help of this disclosure, the timing for ending the reaction cycle or beginning the quench cycle can be determined by monitoring process parameters such as for example time, temperature, and/or pressure.

In an embodiment, a process for producing a poly(arylene sulfide) polymer can comprise a step of cooling the reaction mixture to yield poly(arylene sulfide) polymer particles (e.g., step of cooling the reaction vessel containing the reaction mixture). In an embodiment, the step of cooling the reaction vessel containing the reaction mixture can begin prior to, concurrent with, and/or subsequent to the step of quenching the reaction mixture (e.g., quenching the polymerization reaction). In an embodiment, cooling the reaction mixture (e.g., cooling the reaction vessel containing the reaction mixture) can be a ramped cooling process, wherein the temperature is decreased or lowered in a controlled fashion over time.

In an embodiment, cooling the reaction mixture (e.g., cooling the reaction vessel containing the reaction mixture) can comprise the use of external cooling; jacket cooling; internal cooling; adding a liquid (e.g., quench liquid) to the reaction vessel, wherein the temperature of the quench liquid is lower than the temperature of the reaction mixture (e.g., the temperature inside the reaction vessel); and the like; or combinations thereof.

In an embodiment, cooling the reaction mixture (e.g., cooling the reaction vessel containing the reaction mixture) can cause at least a portion of the poly(arylene sulfide) polymer to precipitate from solution (e.g., reaction mixture), thereby forming a particulate poly(arylene sulfide) (e.g., poly(arylene sulfide) polymer particles). As will be appreciated by one of skill in the art, and with the help of this disclosure, the lower the temperature (e.g., a temperature of the reaction mixture, a temperature inside the reaction vessel), the less soluble the poly(arylene sulfide) polymer.

In an embodiment, a process for producing a poly(arylene sulfide) polymer can comprise a step of processing at least a portion of the poly(arylene sulfide) reaction mixture to obtain a first slurry, wherein processing the poly(arylene sulfide) reaction mixture can comprise (i) washing the poly(arylene sulfide) reaction mixture with a polar organic compound and/or water to obtain a poly(arylene sulfide) polymer (e.g., washed poly(arylene sulfide) polymer) and a first slurry; (ii) treating at least a portion of the poly(arylene sulfide) polymer with an aqueous acid solution and/or an aqueous metal cation solution to obtain a treated poly(arylene sulfide) polymer and a waste aqueous solution; (iii) drying at least a portion of the poly(arylene sulfide) polymer and/or treated poly(arylene sulfide) polymer to obtain a dried poly(arylene sulfide) polymer; and (iv) evaporating a portion of the first slurry to obtain a by-product slurry, wherein the by-product slurry can comprise slurry particulates.

In an embodiment, a process for producing a poly(arylene sulfide) polymer can comprise a step of washing at least a portion of the poly(arylene sulfide) reaction mixture with a polar organic compound and/or water to obtain a poly(arylene sulfide) polymer and a first slurry. In an embodiment, a washing vessel can receive at least a portion of the poly(arylene sulfide) reaction mixture (e.g., the poly(arylene sulfide) reaction mixture can be introduced to a washing vessel), wherein the poly(arylene sulfide) reaction mixture can be washed with a polar organic compound and/or water (e.g., simultaneously or sequentially) to obtain a poly(arylene sulfide) polymer and a first slurry. As will be appreciated by one of skill in the art, and with the help of this disclosure, more than one washing vessel can be used for washing the poly(arylene sulfide) reaction mixture, such as for example two, three, four, five, six, or more washing vessels can be used for washing the poly(arylene sulfide) reaction mixture.

Once the poly(arylene sulfide) has precipitated from solution, a particulate poly(arylene sulfide) can be separated (e.g., recovered, retrieved, obtained, etc.) from the poly(arylene sulfide) reaction mixture (e.g., poly(arylene sulfide) reaction mixture slurry) by any process capable of separating a solid precipitate from a liquid. For purposes of the disclosure herein, the particulate poly(arylene sulfide) separated from the poly(arylene sulfide) reaction mixture will be referred to as “poly(arylene sulfide) polymer particles,” “poly(arylene sulfide) particles,” “particulate poly(arylene sulfide) polymer,” “particulate poly(arylene sulfide),” “poly(arylene sulfide) polymer,” or simply “poly(arylene sulfide).” For purposes of the disclosure herein, poly(arylene sulfide) polymer particles can also be referred to as “neat particulate poly(arylene sulfide) polymer,” “neat particulate poly(arylene sulfide),” “neat poly(arylene sulfide) polymer particles,” “neat poly(arylene sulfide) particles,” “neat poly(arylene sulfide) polymer,” or simply “neat poly(arylene sulfide),” (e.g., “neat PPS”) where a further processing step of combining the poly(arylene sulfide) polymer with a cyclic oligomer nucleating agent is contemplated after separation of the polymer particles from the poly(arylene sulfide) reaction mixture. In various embodiments, the term “neat” can be used to denote poly(arylene sulfide) polymer particles (e.g., PPS particles) prior to combination or contact with a cyclic oligomer nucleating agent (e.g., a cyclic oligomer nucleating agent functioning as an additive to the neat PPS, for example via an additive package or master batch) as described in detail herein. In an embodiment, a neat poly(arylene sulfide) polymer can be combined with a cyclic oligomer nucleating agent to yield a poly(arylene sulfide) polymer composition. In an embodiment, the neat poly(arylene sulfide) polymer comprises a cyclic oligomer nucleating agent in an amount of less than about 3,000 ppmw (0.3 wt. %), alternatively less than about 2,500 ppmw (0.25 wt. %), or alternatively less than about 2,000 ppmw (0.2 wt. %), based on the total weight of the neat poly(arylene sulfide) polymer (ppmw=parts per million weight). As will be appreciated by one of skill in the art, and with the help of this disclosure, although the neat poly(arylene sulfide) polymer contains an amount of cyclic oligomer nucleating agent (e.g., an initial or starting amount, which can be naturally present as a result of the polymer production process), the poly(arylene sulfide) polymer composition contains both the amount of cyclic oligomer nucleating agent that was present in the neat poly(arylene sulfide) polymer (e.g., the initial or starting amount) and the amount of cyclic oligomer nucleating agent that was combined with (e.g., added to, contacted with, etc.) the neat poly(arylene sulfide) polymer to yield the poly(arylene sulfide) polymer composition.

Procedures which can be utilized to separate the poly(arylene sulfide) polymer particles from the reaction mixture slurry can include, but are not limited to, i) filtration, ii) washing the poly(arylene sulfide) polymer particles with a liquid (e.g., water or aqueous solution), or iii) dilution of the reaction mixture with liquid (e.g., water or aqueous solution) followed by filtration and washing the poly(arylene sulfide) polymer particles with a liquid (e.g., water or aqueous solution). In an embodiment, the poly(arylene sulfide) polymer can be separated from the poly(arylene sulfide) reaction mixture by way of a screening process, e.g., passing the poly(arylene sulfide) reaction mixture through a screen (e.g., sieve, mesh, wire screen, wire sieve, wire mesh, etc.), wherein the poly(arylene sulfide) polymer is retained on the screen (e.g., recovered poly(arylene sulfide) polymer).

In an embodiment, in addition to the poly(arylene sulfide) polymer recovered as a solid phase, the procedures utilized to recover the poly(arylene sulfide) polymer from the reaction mixture can also yield a liquid phase comprising both dissolved compounds and suspended or slurried particles (e.g., polymer impurities), as will be discussed in more detail later herein. For purposes of the disclosure herein, such liquid phase will be referred to as “first slurry.” In an embodiment, a tank can receive at least a portion of the first slurry (e.g., the first slurry can be introduced to a tank), wherein the first slurry can be stored prior to further processing.

It should be noted that the process to produce the poly(arylene sulfide) can form a by-product alkali metal halide. The by-product alkali metal halide can be separated from the poly(arylene sulfide) polymer during process steps utilized to separate the poly(arylene sulfide) polymer particles and the first slurry. Generally, the by-product alkali metal halide will be found (e.g., recovered, retrieved, etc.) in the first slurry as dissolved by-product alkali metal halide, slurried by-product alkali metal halide particles, or combinations thereof, based on the solubility of the by-product alkali metal halide in the first slurry, as will be discussed in more detail later herein.

In a non-limiting embodiment, the reaction mixture slurry can be filtered to separate impure poly(arylene sulfide) polymer particles (containing poly(arylene sulfide) or PPS, and by-product alkali metal halide). The impure poly(arylene sulfide) polymer particles can be slurried in a liquid (e.g., water or aqueous solution) and subsequently filtered to remove the alkali metal halide by-product (and/or other liquid, e.g., water, soluble impurities) into the first slurry and to yield purified poly(arylene sulfide) polymer particles. For brevity these purified polymer particles are referred to herein as “poly(arylene sulfide) polymer particles.” As will be appreciated by one of skill in the art, and with the help of this disclosure, during the filtration process to remove the alkali metal halide by-product (and/or other liquid, e.g., water, soluble impurities) into the first slurry, the poly(arylene sulfide) polymer particles are generally retained on the filter (e.g., sieve, screen, etc.), while the alkali metal halide by-product will pass through the filter as dissolved by-product alkali metal halide, slurried by-product alkali metal halide particles, or combinations thereof, as the by-product alkali metal halide particles generally have a smaller size when compared to a size of the poly(arylene sulfide) polymer particles. Generally, the steps of slurrying the poly(arylene sulfide) polymer particles with a liquid followed by filtration to separate the poly(arylene sulfide) polymer particles can occur as many times as necessary to obtain a desired level of purity of the poly(arylene sulfide) polymer, by removing the alkali metal halide by-product (and/or other liquid, e.g., water, soluble impurities, polymer impurities, etc.) into the first slurry.

In an embodiment, the first slurry can comprise water, a polar organic compound (e.g., NMP), an alkali metal halide by-product (e.g., salt, NaCl), poly(arylene sulfide) polymer impurities (e.g., poly(arylene sulfide) oligomers, cyclic oligomer nucleating agents, poly(arylene sulfide) fines, poly(arylene sulfide) low molecular weight polymers, polymerization reaction side-products, polymerization reaction by-products), a halogenated aromatic compound (e.g., p-dichlorobenzene), a molecular weight modifying agent (e.g., an alkali metal carboxylate, sodium acetate), and other impurities. As will be appreciated by one of skill in the art, and with the help of this disclosure, while the first slurry is the liquid phase obtained during one or more filtration processes to recover the poly(arylene sulfide), some insoluble particulates (e.g., poly(arylene sulfide) oligomers, cyclic oligomer nucleating agents, polymer fines, by-product alkali metal halide particles) can pass through a filtering device (e.g., a filter, a screen, a sieve) and be present in such liquid phase (e.g., filtrate), thereby making the liquid phase a slurry. Further, as will be appreciated by one of skill in the art, and with the help of this disclosure, the first slurry can be a very diluted slurry, based on the amount of liquid present in the reaction mixture and the amount of liquid used to wash the particulate poly(arylene sulfide) during the recovery of the poly(arylene sulfide). Further, as will be appreciated by one of skill in the art, and with the help of this disclosure, the amount and type of liquid present in the first slurry influences the solubility of components of the first slurry, and some slurry components (e.g., salts, NaCl, alkali metal carboxylates, sodium acetate) can be partially soluble in the first slurry, e.g., a portion of a slurry component can be present in the first slurry as a dissolved component, while another portion of the same slurry component can be present in the first slurry as a solid particle.

In an embodiment, the first slurry can be subjected to further processing, such as for example to recover the polar organic compound, as will be described in detail later herein. The recovered polar organic compound (e.g., recovered NMP) can be recycled/reused in a subsequent polymerization process for the production of poly(arylene sulfide).

In an embodiment, a process for producing a poly(arylene sulfide) polymer can optionally comprise a step of treating at least a portion of the poly(arylene sulfide) polymer (e.g., poly(arylene sulfide) polymer particles) with an aqueous acid solution and/or an aqueous metal cation solution to obtain a treated poly(arylene sulfide) polymer, wherein the treated poly(arylene sulfide) polymer can be recovered from a treatment solution via a separation (e.g., filtration) step.

In an embodiment, the poly(arylene sulfide) polymer can be treated with an aqueous acid solution and/or can be treated with an aqueous metal cation solution, to yield treated poly(arylene sulfide) (e.g., acid treated poly(arylene sulfide) and/or metal cation treated poly(arylene sulfide)). Additionally, the poly(arylene sulfide) polymer can be dried to remove liquid adhering to the poly(arylene sulfide) polymer particles. Generally, the poly(arylene sulfide) polymer which can be treated can be i) the poly(arylene sulfide) polymer particles separated from the reaction mixture or ii) the poly(arylene sulfide) polymer particles which have been washed with a liquid (e.g., water) and filtered to remove the alkali metal halide by-product (and/or other liquid soluble impurities). The poly(arylene sulfide) polymer particles which can be treated can either be liquid wet or dry; alternatively, liquid wet; or alternatively, dry.

Acid treatment can comprise a) contacting the poly(arylene sulfide) with water to form a poly(arylene sulfide) slurry, b) contacting the poly(arylene sulfide) slurry with an acidic compound to form an acidic mixture, c) heating the acidic mixture in the substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the poly(arylene sulfide) with an aqueous solution comprising an acidic compound to form an acidic mixture, b) heating the acidic mixture in the substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,664, which is incorporated by reference herein in its entirety.

Generally, the metal cation treatment can comprise a) contacting the poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in the substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in the substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppmw to about 10,000 ppmw, from about 75 ppmw to about 7,500 ppmw, or from about 100 ppmw to about 5,000 ppmw. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the metal cation treatment process are provided in U.S. Pat. No. 4,588,789, which is incorporated by reference herein in its entirety.

Once the poly(arylene sulfide) has been acid treated and/or metal cation treated, the acid treated and/or metal cation treated poly(arylene sulfide) can be separated from a treatment solution via a filtration step, to yield a treated poly(arylene sulfide) polymer and a waste aqueous solution. Generally, the process/steps for recovering the acid treated and/or metal cation treated poly(arylene sulfide) can be the same steps as those for separating and/or isolating the poly(arylene sulfide) polymer particles from the reaction mixture. The waste aqueous solution can be discarded or disposed of.

Once the poly(arylene sulfide) polymer particles have been recovered (either untreated, acid treated, metal cation treated, or acid treated and metal cation treated form), the poly(arylene sulfide) can be dried and optionally cured. In an embodiment, a process for producing a poly(arylene sulfide) polymer can comprise a step of drying at least a portion of the poly(arylene sulfide) polymer particles to obtain a dried poly(arylene sulfide) polymer.

Generally, the poly(arylene sulfide) drying process can be performed at any temperature which can substantially dry the poly(arylene sulfide), to yield a dried poly(arylene sulfide) polymer. Preferably, a drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) polymer particles to an elevated temperature, below its melting point, in the presence of gaseous oxidizing atmosphere, thereby forming cured poly(arylene sulfide) polymer (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyalphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, a process for producing a poly(arylene sulfide) polymer can comprise the step of removing a portion of the first slurry (e.g., evaporating a portion of a liquid phase of a first slurry) to obtain a by-product slurry, wherein the by-product slurry comprises slurry particulates. As will be appreciated by one of skill in the art, and with the help of this disclosure, at least a portion of the slurry particulates present in the by-product slurry have also been present in the first slurry. Further, as will be appreciated by one of skill in the art, and with the help of this disclosure, during the evaporation of a portion of the first slurry to obtain a by-product slurry, some of the particulates present in the first slurry can combine (e.g., aggregate, agglomerate, stick together, etc.) to produce the slurry particulates present in the by-product slurry. Without wishing to be limited by theory, during the evaporation of a portion of the first slurry to obtain a by-product slurry, some compounds that could be at least partially soluble in the first slurry, might not be as soluble in the by-product slurry and could precipitate out of the by-product slurry solution, due to either a reduction in liquid volume and/or a modification in the composition of a liquid phase of the by-product slurry when compared to a liquid phase of the first slurry. In an embodiment, the slurry particulates of the by-product slurry can comprise an alkali metal halide by-product (e.g., salt, NaCl), poly(arylene sulfide) polymer impurities (e.g., poly(arylene sulfide) oligomers, cyclic oligomer nucleating agents, poly(arylene sulfide) fines, poly(arylene sulfide) low molecular weight polymers, polymerization reaction side-products, polymerization reaction by-products), a molecular weight modifying agent (e.g., an alkali metal carboxylate, sodium acetate), and the like, or combinations thereof. In an embodiment, the by-product slurry can comprise slurry particulates, dissolved salts (e.g., dissolved NaCl, dissolved alkali metal carboxylates, dissolved sodium acetate), a polar organic compound, water, and the like. As will be appreciated by one of skill in the art, and with the help of this disclosure, the amount and type of liquid present in the by-product slurry influences the solubility of components of the by-product slurry, and some slurry components (e.g., salts, NaCl, alkali metal carboxylates, sodium acetate) can be partially soluble in the by-product slurry, e.g., a portion of a slurry component can be present in the by-product slurry as a dissolved component (e.g., dissolved salt), while another portion of the same slurry component can be present in the by-product slurry as a solid particulate (e.g., slurry particulate).

In an embodiment, the step of evaporating a portion of the first slurry to obtain a by-product slurry can be accomplished by heating the first slurry, such as for example by external heating; by placing the first slurry in a jacketed vessel wherein hot water and/or steam can be run through a jacket of such vessel; by electrical heating; by internal heating; by contacting steam with a portion of the first slurry; and the like; or combinations thereof. In an embodiment, at least a portion of the first slurry can be transferred to a concentrator (e.g., a concentrator can receive at least a portion of the first slurry) for evaporating a portion of the first slurry to yield a by-product slurry. As will be appreciated by one of skill in the art, more than one concentrator can be used for evaporating a portion of the first slurry to yield the by-product slurry, such as for example two, three, four, five, six, or more concentrators can be used for evaporating a portion of the first slurry.

In an embodiment, the step of evaporating a portion of the first slurry to obtain a by-product slurry can yield one or more vapor streams. As will be appreciated by one of skill in the art, and with the help of this disclosure, a vapor stream can condense (i.e., change physical state from gas phase into liquid phase) to form a liquid fraction. In an embodiment, the one or more vapor streams can yield one or more first liquid fractions, wherein the one or more first liquid fractions can comprise water, a halogenated aromatic compound, a polar organic compound, or combinations thereof.

In an embodiment, the first liquid fractions can be further subjected to a step for the recovery of the halogenated aromatic compound and/or polar organic compound (e.g., a distillation step), to yield a recovered halogenated aromatic compound and/or a first recovered polar organic compound (e.g., recovered polar organic compound, recovered NMP, first recovered NMP). In an embodiment, at least a portion of the recovered halogenated aromatic compound and/or the first recovered polar organic compound can be recycled/reused in a subsequent polymerization process for the production of poly(arylene sulfide). In an embodiment, the step of evaporating a portion of the first slurry to obtain a by-product slurry can comprise two or more sub-steps, such as for example a first sub-step wherein an aqueous liquid fraction is recovered, followed by a second sub-step, wherein an organic liquid fraction is recovered.

In an embodiment, at least a portion of the first recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer and a by-product slurry. In an embodiment, at least a portion of the first recovered polar organic compound can be recycled/reused in a step of washing the poly(arylene sulfide) reaction mixture with a polar organic compound and/or water to obtain a poly(arylene sulfide) polymer and a first slurry.

In an embodiment, a process for producing a poly(arylene sulfide) polymer can comprise a step of removing (e.g., evaporating) at least a portion of the by-product slurry to yield salt solids particulates. In an embodiment, the step of removing (e.g., evaporating) at least a portion of the by-product slurry to yield salt solids particulates comprises removing (e.g., evaporating) at least a portion of the polar organic compound and/or water from the by-product slurry to yield salt solids particulates.

In an embodiment, the step of evaporating at least a portion of the by-product slurry to yield salt solids particulates comprises introducing at least a portion of the by-product slurry to a dryer, wherein at least a portion of liquid (e.g., a polar organic compound and/or water) in the by-product slurry can be evaporated. In an embodiment, the by-product slurry can be introduced (e.g., fed) to a dryer, to yield salt solids particulates and a second recovered polar organic compound (e.g., a second recovered NMP). In an embodiment, at least a portion of the second recovered polar organic compound can be recycled/reused in subsequent polymerization processes for the production of poly(arylene sulfide).

In an embodiment, the second recovered polar organic compound can be further processed (e.g., dehydrated, purified, etc.) and/or recycled/reused in subsequent polymerization processes for the production of poly(arylene sulfide). In an embodiment, the second recovered polar organic compound can be further subjected to a dehydration process (e.g., water removal process) and/or to a purification process (e.g., distillation) prior to being recycled/reused in subsequent polymerization processes for the production of poly(arylene sulfide).

In an embodiment, at least a portion of the second recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) reaction mixture downstream product. In an embodiment, at least a portion of the second recovered polar organic compound can be recycled/reused in a step of washing the poly(arylene sulfide) reaction mixture with a polar organic compound and/or water to obtain a poly(arylene sulfide) polymer and a first slurry.

In an embodiment, the salt solids particulates can originate from the by-product slurry, and can comprise slurry particulates, combined (e.g., aggregated, agglomerated, stuck together, joined together, etc.) slurry particulates, and particulates that precipitate out of the solution as the amount of the liquid phase of the slurry diminishes due to the evaporation and/or recovery of polar organic compound, wherein the particulates that precipitate out of the solution can originate in the dissolved salts of the by-product slurry (e.g., dissolved NaCl, dissolved alkali metal carboxylates, dissolved sodium acetate).

In an embodiment, the salt solids particulates can comprise an alkali metal halide by-product (e.g., salt, NaCl) and poly(arylene sulfide) polymer impurities (e.g., poly(arylene sulfide) oligomers, cyclic oligomer nucleating agents, poly(arylene sulfide) fines, poly(arylene sulfide) low molecular weight polymers, polymerization reaction side-products, polymerization reaction by-products). In an embodiment, the salt solids particulates can further comprise a molecular weight modifying agent (e.g., an alkali metal carboxylate, sodium acetate). As will be appreciated by one of skill in the art, and with the help of this disclosure, other impurities, such as for example traces of reagents, by-products of the polymerization reaction, and the like, can also be present in the salt solids particulates.

In an embodiment, the salt solids particulates can comprise an alkali metal halide by-product (e.g., salt, NaCl) in an amount of from about 50 wt. % to about 99 wt. %, alternatively, from about 75 wt. % to about 95 wt. %, or alternatively, from about 80 wt. % to about 90 wt. %, based on the total weight of the salt solids particulates. In an embodiment, the alkali metal halide by-product (e.g., salt, NaCl) can comprise the balance of the salt solids particulates after considering the amount of the other components. In an embodiment, the alkali metal halide by-product comprises NaCl.

In an embodiment, the salt solids particulates can comprise polymer impurities in an amount of from about 1 wt. % to about 50 wt. %, alternatively, from about 5 wt. % to about 25 wt. %, or alternatively, from about 10 wt. % to about 20 wt. %, based on the total weight of the salt solids particulates. In an embodiment, the polymer impurities can comprise a cyclic oligomer nucleating agent, poly(arylene sulfide) fines, poly(arylene sulfide) low molecular weight polymers, and the like, or combinations thereof.

In an embodiment, the salt solids particulates can further comprise a polar organic compound, e.g., a polar organic compound that was not removed in the dryer. In an embodiment, the salt solids particulates can comprise a polar organic compound in an amount of equal to or less than about 5 wt. %, alternatively less than about 1 wt. %, alternatively less than about 0.5 wt. %, alternatively less than about 0.1 wt. %, alternatively less than about 0.01 wt. %, alternatively less than about 0.001 wt. %, alternatively less than about 0.0001 wt. %, or alternatively about 0 wt. %, based on the total weight of the salt solids particulates.

In an embodiment, a process for producing a poly(arylene sulfide) polymer can comprise a step of recovering at least a portion of the polymer impurities from the salt solids particulates, wherein the polymer impurities comprise a cyclic oligomer nucleating agent. In an embodiment, the step of recovering at least a portion of the polymer impurities from the salt solids particulates comprises (i) solubilizing at least a portion of the salt solids particulates in water or an aqueous solution to yield a polymer impurities aqueous solution, wherein the polymer impurities are slurried in the polymer impurities aqueous solution; and (ii) separating at least a portion of the polymer impurities from the polymer impurities aqueous solution.

In an embodiment, solubilizing at least a portion of the salt solids particulates in water or an aqueous solution to yield a polymer impurities aqueous solution can comprise contacting at least a portion of the salt solids particulates with water or an aqueous solution.

In an embodiment, solubilizing at least a portion of the salt solids particulates in water or an aqueous solution can further comprise stifling or agitating the polymer impurities aqueous solution to ensure solubilizing at least a portion of the salt solids particulates. In an embodiment, the polymer impurities aqueous solution can be stirred by using any suitable agitation means. In an embodiment, the polymer impurities aqueous solution can be stirred by using stifling tools; a rotary agitator; a magnetic stirrer; by bubbling or sparging an inert gas through the polymer impurities aqueous solution; and the like, or combinations thereof.

In an embodiment, solubilizing at least a portion of the salt solids particulates in water or an aqueous solution can further comprise heating the polymer impurities aqueous solution to ensure solubilizing at least a portion of the salt solids particulates. In an embodiment, the polymer impurities aqueous solution can be heated by using any suitable heating means, such as for example external heating, jacket heating, internal heating, contacting steam with the polymer impurities aqueous solution, and the like, or combinations thereof. In some embodiments, the water or an aqueous solution could be heated prior to contacting with the salt solids particulates to yield the polymer impurities aqueous solution.

As will be appreciated by one of skill in the art, and with the help of this disclosure, the alkali metal halide by-product (e.g., salt, NaCl) of the salt solids particulates will solubilize in the polymer impurities aqueous solution, since the alkali metal halide by-product is generally a water soluble salt. Further, as will be appreciated by one of skill in the art, and with the help of this disclosure, other water soluble impurities, such as for example the molecular weight modifying agent (e.g., an alkali metal carboxylate, sodium acetate), will solubilize in the polymer impurities aqueous solution. Further, as will be appreciated by one of skill in the art, and with the help of this disclosure, the polymer impurities are generally insoluble in water and will be slurried in the polymer impurities aqueous solution as insoluble particulates.

In an embodiment, separating at least a portion of the polymer impurities from the polymer impurities aqueous solution can comprise the use of any suitable means for separating a solid from a liquid. In an embodiment, separating at least a portion of the polymer impurities from the polymer impurities aqueous solution can comprise filtering, screening, centrifuging, precipitating, and the like, or combinations thereof.

In an embodiment, a process for producing a poly(arylene sulfide) polymer can comprise a step of recovering at least a portion of the cyclic oligomer nucleating agent from the polymer impurities. In an embodiment, recovering at least a portion of the cyclic oligomer nucleating agent from the polymer impurities can comprise (i) solubilizing at least a portion of the polymer impurities in a polar organic compound having a temperature of from about 100° C. to about 205° C., alternatively from about 110° C. to about 200° C., or alternatively from about 120° C. to about 190° C., to yield a cyclic oligomer nucleating agent solution, wherein the solution comprises dissolved cyclic oligomer nucleating agent and slurried polymer particulates, wherein the slurried polymer particulates comprise poly(arylene sulfide) polymer fines, poly(arylene sulfide) low molecular weight polymers, and the like, or combinations thereof; (ii) separating at least a portion of the slurried polymer particulates from the cyclic oligomer nucleating agent solution to yield a particulate-free cyclic oligomer nucleating agent solution; (iii) cooling at least a portion of the particulate-free cyclic oligomer nucleating agent solution to a temperature of from about 0° C. to about 90° C., alternatively from about 5° C. to about 80° C., or alternatively from about 10° C. to about 75° C., to yield cyclic oligomer nucleating agent particles and the polar organic compound, wherein the cyclic oligomer nucleating agent particles are slurried in the polar organic compound; and (iv) separating at least a portion of the cyclic oligomer nucleating agent particles from the polar organic compound to yield the cyclic oligomer nucleating agent.

In an embodiment, recovering at least a portion of the cyclic oligomer nucleating agent from the polymer impurities can comprise (i) solubilizing at least a portion of the polymer impurities in a polar organic compound having a first temperature to yield a cyclic oligomer nucleating agent solution, wherein the solution comprises dissolved cyclic oligomer nucleating agent and slurried polymer particulates, wherein the slurried polymer particulates comprise poly(arylene sulfide) polymer fines, poly(arylene sulfide) low molecular weight polymers, or combinations thereof; (ii) separating at least a portion of the slurried polymer particulates from the cyclic oligomer nucleating agent solution to yield a particulate-free cyclic oligomer nucleating agent solution; (iii) cooling at least a portion of the particulate-free cyclic oligomer nucleating agent solution to a second temperature to yield cyclic oligomer nucleating agent particles and the polar organic compound, wherein the cyclic oligomer nucleating agent particles are slurried in the polar organic compound, and wherein the difference between the first temperature and the second temperature is from about 10° C. to about 200° C., alternatively from about 20° C. to about 190° C., or alternatively from about 30° C. to about 180° C.; and (iv) separating at least a portion of the cyclic oligomer nucleating agent particles from the polar organic compound to yield the cyclic oligomer nucleating agent.

In an embodiment, solubilizing at least a portion of the polymer impurities in a polar organic compound can comprise heating the polar organic compound and/or the cyclic oligomer nucleating agent solution to the first temperature (e.g., a temperature of from about 100° C. to about 205° C., alternatively from about 110° C. to about 200° C., or alternatively from about 120° C. to about 190° C.) to ensure solubilizing at least a portion of the cyclic oligomer nucleating agent. In an embodiment, the cyclic oligomer nucleating agent solution can be heated by using any suitable heating means, such as for example external heating, jacket heating, internal heating, and the like, or combinations thereof.

In an embodiment, the cyclic oligomer nucleating agent solution comprises dissolved cyclic oligomer nucleating agent and slurried polymer particulates, wherein the slurried polymer particulates comprise poly(arylene sulfide) polymer fines, poly(arylene sulfide) low molecular weight polymers, and the like, or combinations thereof. As will be appreciated by one of skill in the art, and with the help of this disclosure, the first temperature is chosen such that the cyclic oligomer nucleating agent will solubilize in the polar organic compound to yield the dissolved cyclic oligomer nucleating agent. Further, as will be appreciated by one of skill in the art, and with the help of this disclosure, the first temperature is chosen such that the other polymer impurities (e.g., poly(arylene sulfide) polymer fines, poly(arylene sulfide) low molecular weight polymers, etc.) will not substantially solubilize in the polar organic compound, thereby yielding slurried polymer particulates. Without wishing to be limited by theory, a molecular weight of the cyclic oligomer nucleating agent is lower than a molecular weight of the slurried polymer particulates (e.g., poly(arylene sulfide) polymer fines, poly(arylene sulfide) low molecular weight polymers, etc.), thus leading to the cyclic oligomer nucleating agent being soluble in the polar organic compound at a temperature (e.g., first temperature) that is lower than a temperature at which the slurried polymer particulates would be soluble in the polar organic compound.

In an embodiment, the poly(arylene sulfide) polymer fines and/or the poly(arylene sulfide) low molecular weight polymers can be characterized by a solubility in the polar organic compound at the first temperature of less than about 5 wt. %, alternatively less than about 1 wt. %, alternatively less than about 0.5 wt. %, alternatively less than about 0.1 wt. %, alternatively less than about 0.01 wt. %, alternatively less than about 0.001 wt. %, alternatively less than about 0.0001 wt. %, or alternatively about 0 wt. %, based on the total weight of the cyclic oligomer nucleating agent solution.

In an embodiment, solubilizing at least a portion of the polymer impurities in a polar organic compound can further comprise stifling the cyclic oligomer nucleating agent solution to ensure solubilizing at least a portion of the cyclic oligomer nucleating agent. In an embodiment, the cyclic oligomer nucleating agent solution can be stirred by using any suitable agitation means. In an embodiment, the cyclic oligomer nucleating agent solution can be stirred by using stirring tools; a rotary agitator; a magnetic stirrer; by bubbling or sparging an inert gas through the cyclic oligomer nucleating agent solution; and the like, or combinations thereof.

In an embodiment, separating at least a portion of the slurried polymer particulates from the cyclic oligomer nucleating agent solution can comprise the use of any suitable means for separating a solid from a liquid. In an embodiment, separating at least a portion of the slurried polymer particulates from the cyclic oligomer nucleating agent solution can comprise filtering, screening, centrifugation, and the like, or combinations thereof. In an embodiment, the slurried polymer particulates can be discarded or disposed of.

In an embodiment, cooling at least a portion of the particulate-free cyclic oligomer nucleating agent solution to a second temperature (e.g., a temperature of from about 0° C. to about 90° C., alternatively from about 5° C. to about 80° C., or alternatively from about 10° C. to about 75° C.) can be facilitated by the use of cooling jackets or coils, a cooling heat exchanger, and the like, or combinations thereof. As will be appreciated by one of skill in the art, and with the help of this disclosure, the second temperature (which is lower than the first temperature) is chosen such that the cyclic oligomer nucleating agent will precipitate out of the solution to yield cyclic oligomer nucleating agent particles. Further, as will be appreciated by one of skill in the art, and with the help of this disclosure, a solubility of the cyclic oligomer nucleating agent at the second temperature is lower than a solubility of the cyclic oligomer nucleating agent at the first temperature.

In some embodiments, formation of cyclic oligomer nucleating agent particles (e.g., precipitating the cyclic oligomer nucleating agent out of the cyclic oligomer nucleating agent solution) can comprise cooling the cyclic oligomer nucleating agent solution to the second temperature; evaporating at least a portion of a liquid phase (e.g., polar organic compound) of the cyclic oligomer nucleating agent solution; contacting the cyclic oligomer nucleating agent solution with water and/or an aqueous solution; and the like; or combinations thereof. In such embodiments, evaporating at least a portion of the liquid phase of the cyclic oligomer nucleating agent solution can be conducted under vacuum or partial vacuum.

As will be appreciated by one of skill in the art, and with the help of this disclosure, some cyclic oligomer nucleating agents are soluble in polar organic compounds at room temperature, so, in order to facilitate the formation of cyclic oligomer nucleating agent particles, water and/or an aqueous solution can be added to the cyclic oligomer nucleating agent solution, and/or at least a portion of the liquid phase of the cyclic oligomer nucleating agent solution can be removed/evaporated.

In an embodiment, the dissolved cyclic oligomer nucleating agent will precipitate out of the solution to yield cyclic oligomer nucleating agent particles in an amount of greater than about 90 wt. %, alternatively greater than about 95 wt. %, alternatively greater than about 96 wt. %, alternatively greater than about 97 wt. %, alternatively greater than about 98 wt. %, or alternatively greater than about 99 wt. %, based on the total weight of the dissolved cyclic oligomer nucleating agent.

In an embodiment, separating at least a portion of the cyclic oligomer nucleating agent particles from the polar organic compound can comprise the use of any suitable means for separating a solid from a liquid. In an embodiment, separating at least a portion of the cyclic oligomer nucleating agent particles from the polar organic compound can comprise filtering, screening, centrifugation, and the like, or combinations thereof. In an embodiment, the polar organic compound separated from the cyclic oligomer nucleating agent particles can be recycled/reused in a subsequent process for the production of poly(arylene sulfide).

In an embodiment, the cyclic oligomer nucleating agent separated from the polar organic compound can be further dried to yield a cyclic oligomer nucleating agent powder. In an embodiment, the separated cyclic oligomer nucleating agent can be dried by using any suitable drying means, such as for example air drying, desiccant drying, molecular sieves drying, oven drying, spray drying, fluidized bed drying, and the like, or combinations thereof.

In an embodiment, the cyclic oligomer nucleating agent can comprise a compound characterized by Structure I:

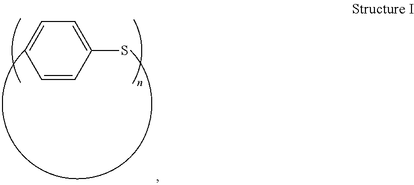

wherein n can be from 4 to 20, alternatively from 4 to 12, or alternatively from 4 to 10. In some embodiments, the cyclic oligomer nucleating agent can comprise a cyclic oligomer with a structure similar to Structure I, wherein the structure comprises the sulfur atom in an ortho and/or meta position (as opposed to a para position as depicted in Structure I).

In an embodiment, the cyclic oligomer nucleating agent can comprise a compound characterized by Structure I, wherein n can be equal to 6, n can be equal to 8, or combinations thereof.

In an embodiment, the cyclic oligomer nucleating agent can be characterized by a weight average molecular weight of from about 400 kg/mol to about 1,500 kg/mol, alternatively from about 500 kg/mol to about 1,300 kg/mol, or alternatively from about 600 kg/mol to about 900 kg/mol. The weight average molecular weight describes the size average of a polymeric material (e.g., oligomer) and can be calculated according to equation 1:

$${M}_{w} = \frac{{\sum }_{i} {N}_{i} {M}_{i}^{2}}{{\sum }_{i} {N}_{i} {M}_{i}} \qquad ( 1 )$$

wherein Nᵢ is the number of molecules of molecular weight Mᵢ. All molecular weight averages are expressed in gram per mole (g/mol) or Daltons (Da).

In some embodiments, the cyclic oligomer nucleating agent can comprise a by-product of a poly(arylene sulfide) polymerization reaction. In other embodiments, the cyclic oligomer nucleating agent can be synthesized by an oligomerization reaction, wherein the cyclic oligomer nucleating agent is the intended product of the reaction (e.g., the cyclic oligomer nucleating agent is not a by-product of a polymerization and/or oligomerization reaction).

In an embodiment, an additive pack can comprise the cyclic oligomer nucleating agent. In such embodiment, the cyclic oligomer nucleating agent can be in powder form. In an embodiment, the additive pack can further comprise polymers, fillers, fibers, reinforcing materials, pigments, nucleating agents, antioxidants, ultraviolet stabilizers, ultraviolet absorbers, lubricants, fire retardants, heat stabilizers, carbon black, plasticizers, corrosion inhibitors, mold release agents, colorants, titanium dioxide, clay, mica, processing aids, adhesives, tackifiers, and the like, or combinations thereof.

In an embodiment, the additive pack can be contacted or combined with a neat poly(arylene sulfide) polymer during a processing step (e.g., melt processing) of the polymer to yield a poly(arylene sulfide) polymer composition.

In an alternative embodiment, nucleating agents (other than the cyclic oligomer nucleating agent) could also be contacted or combined with the neat poly(arylene sulfide) polymer to yield a poly(arylene sulfide) polymer composition. Nonlimiting examples of nucleating agents suitable for use in the present disclosure include polyphenylene sulfide ketone (PPSK); polyphenylene sulfide sulfone ketone (PPSSK); oligomers of PPSK; oligomers of PPSSK; small molecule analogs of PPSK; small molecule analogs of PPSSK; a compound characterized by Structure II:

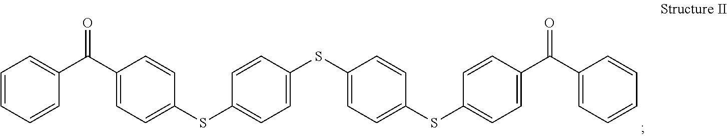 [SMILES: O=C(c1ccccc1)c1ccc(Sc2ccc(Sc3ccc(Sc4ccc(C(=O)c5ccccc5)cc4)cc3)cc2)cc1]

a compound characterized by Structure III:

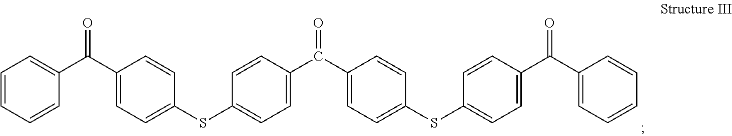 [SMILES: O=C(c1ccccc1)c1ccc(Sc2ccc(C(=O)c3ccc(Sc4ccc(C(=O)c5ccccc5)cc4)cc3)cc2)cc1]

a compound characterized by Structure IV:

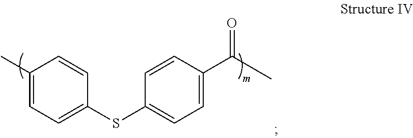

wherein m can be from 2 to 20, alternatively from 3 to 12, or alternatively from 4 to 10; and the like, or combinations thereof.

In an embodiment, a process for producing a poly(arylene sulfide) polymer can comprise a step of contacting or combining at least a portion of the cyclic oligomer nucleating agent with at least a portion of a neat poly(arylene sulfide) polymer to yield a poly(arylene sulfide) polymer composition. In such embodiment, the cyclic oligomer nucleating agent can be contacted or combined with the neat poly(arylene sulfide) polymer in an amount of from about 0.25 wt. % to about 1 wt. % cyclic oligomer nucleating agent, alternatively from about 0.3 wt. % to about 0.95 wt. % cyclic oligomer nucleating agent, or alternatively from about 0.35 wt. % to about 0.9 wt. % cyclic oligomer nucleating agent, based on the total weight of the poly(arylene sulfide) polymer composition.

In an embodiment, a poly(arylene sulfide) polymer composition can comprise a neat poly(arylene sulfide) polymer and a cyclic oligomer nucleating agent; wherein the neat poly(arylene sulfide) polymer comprises the cyclic oligomer nucleating agent in an amount of less than about 3,000 ppmw (0.3 wt. %), alternatively less than about 2,500 ppmw (0.25 wt. %), or alternatively less than about 2,000 ppmw (0.2 wt. %), based on the total weight of the neat poly(arylene sulfide) polymer; and wherein the poly(arylene sulfide) polymer composition comprises the cyclic oligomer nucleating agent in an amount of from about 2,500 ppmw (0.25 wt. %) to about 13,000 ppmw (1.3 wt. %), alternatively from about 3,000 ppmw (0.3 wt. %) to about 12,500 ppmw (1.25 wt. %), or alternatively from about 3,500 ppmw (0.35 wt. %) to about 12,000 ppmw (1.2 wt. %), based on the total weight of the poly(arylene sulfide) polymer composition.

In an embodiment, a process for producing a poly(arylene sulfide) polymer composition can comprise a step of contacting or combining at least a portion of the cyclic oligomer nucleating agent with at least a portion of the neat poly(arylene sulfide) polymer to yield a poly(arylene sulfide) polymer composition, wherein the cyclic oligomer nucleating agent is a by-product of a poly(arylene sulfide) polymerization reaction and wherein the neat poly(arylene sulfide) polymer is a product of a polymerization process comprising a quench termination step. In another embodiment, a process for producing a poly(arylene sulfide) polymer composition can comprise a step of contacting or combining at least a portion of the cyclic oligomer nucleating agent with at least a portion of the neat poly(arylene sulfide) polymer to yield a poly(arylene sulfide) polymer composition, wherein the cyclic oligomer nucleating agent is a by-product of a poly(arylene sulfide) polymerization process that produces the neat poly(arylene sulfide) polymer and wherein the neat poly(arylene sulfide) polymer is a product of a polymerization process comprising a quench termination step.

In an embodiment, the poly(arylene sulfide) polymer composition can be prepared by (i) isolating a cyclic oligomer nucleating agent from a polymer production process (e.g., a polymer production process comprising a quench termination step); and (ii) contacting at least a portion of the isolated cyclic oligomer nucleating agent with at least a portion of the neat poly(arylene sulfide) polymer. In another embodiment, the poly(arylene sulfide) polymer composition can be prepared by (i) isolating a cyclic oligomer nucleating agent from a polymer production process (e.g., a polymer production process comprising a quench termination step), wherein the polymer production process produces a neat poly(arylene sulfide) polymer; and (ii) contacting at least a portion of the isolated cyclic oligomer nucleating agent with at least a portion of the neat poly(arylene sulfide) polymer.

In an embodiment, the poly(arylene sulfide) polymer composition can be prepared by combining or contacting a master batch comprising the cyclic oligomer nucleating agent with at least a portion of a neat poly(arylene sulfide) polymer. In an embodiment, the master batch comprising the cyclic oligomer nucleating agent can be prepared by contacting at least a portion of the cyclic oligomer nucleating agent with at least a portion of a neat poly(arylene sulfide) polymer in an amount of from about 5 wt. % to about 49 wt. % cyclic oligomer nucleating agent, alternatively from about 10 wt. % to about 45 wt. % cyclic oligomer nucleating agent, or alternatively from about 15 wt. % to about 40 wt. % cyclic oligomer nucleating agent, based on the total weight of the master batch comprising the cyclic oligomer nucleating agent.

In an embodiment, the poly(arylene sulfide) polymer composition can be prepared by combining or contacting at least a portion of (e.g., an effective amount) the master batch comprising the cyclic oligomer nucleating agent with at least a portion of the neat poly(arylene sulfide) polymer to yield a poly(arylene sulfide) polymer composition; wherein the neat poly(arylene sulfide) polymer comprises the cyclic oligomer nucleating agent in an amount of less than about 3,000 ppmw (0.3 wt. %), alternatively less than about 2,500 ppmw (0.25 wt. %), or alternatively less than about 2,000 ppmw (0.2 wt. %), based on the total weight of the neat poly(arylene sulfide) polymer; and wherein the cyclic oligomer nucleating agent is added to the neat poly(arylene sulfide) polymer in an amount from about 2,500 ppmw (0.25 wt. %) to about 10,000 ppmw (1 wt. %), alternatively from about 3,000 ppmw (0.3 wt. %) to about 9,500 ppmw (0.95 wt. %), or alternatively from about 3,500 ppmw (0.35 wt. %) to about 9,000 ppmw (0.9 wt. %), based on the total weight of the poly(arylene sulfide) polymer composition.

In an embodiment, the cyclic oligomer nucleating agent and the neat poly(arylene sulfide) polymer can be contacted or combined to yield a poly(arylene sulfide) polymer composition and/or a master batch comprising the cyclic oligomer nucleating agent by using any suitable mixing means, such as for example a mixer, a blender, a shaker, a fluidized bed mixer, a rotary mixer, an acoustic mixer, a rotary blender, a ribbon blender, a plow blender, a paddle blender, and the like, or combinations thereof.

In an embodiment, the poly(arylene sulfide) polymer composition and/or the master batch comprising the cyclic oligomer nucleating agent can be further processed by melt processing as previously described herein for the poly(arylene sulfide) polymer.

In an embodiment, contacting or combining at least a portion of the cyclic oligomer nucleating agent with at least a portion of the neat poly(arylene sulfide) polymer can comprise mixing the cyclic oligomer nucleating agent and the neat poly(arylene sulfide) polymer to yield a master batch composition comprising the cyclic oligomer nucleating agent; melting at least a portion of the master batch composition to yield a molten master batch composition; and extruding at least a portion of the molten master batch composition to yield master batch pellets comprising the cyclic oligomer nucleating agent, wherein the amounts of the cyclic oligomer nucleating agent are described herein.

In an embodiment, an additive pack can comprise a master batch comprising the cyclic oligomer nucleating agent, wherein the master batch comprising the cyclic oligomer nucleating agent comprises pellets. In such embodiment, the additive pack can be contacting or combined with a neat poly(arylene sulfide) polymer during a processing step (e.g., melt processing) of the polymer to yield a poly(arylene sulfide) polymer composition having amounts of the cyclic oligomer nucleating agent as described herein.

In an embodiment, contacting or combining at least a portion of the cyclic oligomer nucleating agent with at least a portion of the neat poly(arylene sulfide) polymer can comprise mixing the cyclic oligomer nucleating agent with the neat poly(arylene sulfide) polymer to yield the poly(arylene sulfide) polymer composition having amounts of the cyclic oligomer nucleating agent as described herein; melting at least a portion of the poly(arylene sulfide) polymer composition to yield a molten poly(arylene sulfide) polymer composition; and melt processing (e.g., injection molding, extruding, etc.) at least a portion of the molten poly(arylene sulfide) polymer composition to yield poly(arylene sulfide) polymer composition articles.

In another embodiment, combining the cyclic oligomer nucleating agent with the neat poly(arylene sulfide) polymer can comprise mixing the master batch comprising the cyclic oligomer nucleating agent with the neat poly(arylene sulfide) polymer to yield the poly(arylene sulfide) polymer composition having amounts of the cyclic oligomer nucleating agent as described herein; melting at least a portion of the poly(arylene sulfide) polymer composition to yield a molten poly(arylene sulfide) polymer composition; and melt processing (e.g., injection molding, extruding, etc.) at least a portion of the molten poly(arylene sulfide) polymer composition to yield poly(arylene sulfide) polymer composition articles.

In an embodiment, the melt processing of the poly(arylene sulfide) polymer composition can comprise injection molding. Generally, injection molding is a manufacturing process for producing parts by injecting a material (e.g., a polymer, a poly(arylene sulfide) polymer, a poly(arylene sulfide) polymer composition, etc.) into a mold. A material can be introduced into a heated barrel through a hopper, wherein the material can be mixed and melted inside the barrel to yield a molten material. The molten material can be injected (e.g., forced) under pressure into a mold cavity, wherein the molten material can be allowed to cool and solidify, thereby taking the shape of the mold. Injection molding is generally characterized by an injection molding cycle time, wherein the injection molding cycle time accounts for closing and securing the mold; injecting the molten material into the mold; and cooling the molten material into a molded part. As will be appreciated by one of skill in the art, and with the help of this disclosure, cooling the molten material constitutes the majority of the injection molding cycle time.

In an embodiment, the poly(arylene sulfide) polymer composition can be characterized by a melt crystallization temperature (Tmc) that is greater by at least about 5° C., alternatively greater by about 10° C., or alternatively greater by about 15° C., than a Tmc of the neat poly(arylene sulfide) polymer from which the poly(arylene sulfide) polymer composition was formed. Generally, the melt crystallization temperature (Tmc) of a polymer refers to the temperature at which the polymer transitions to a crystalline state, and it can be measured by differential scanning calorimetry according to ASTM D3418-12.

Without wishing to be limited by theory, the cyclic oligomer nucleating agent present in the poly(arylene sulfide) polymer composition provides nucleating sites for the transition of the polymer from a molten state to the crystalline state, e.g., nuclei for the growth of crystals in the polymer melt. Further, without wishing to be limited by theory, an increased number of nuclei (e.g., increased amount of/concentration of cyclic oligomer nucleating agent) allows for the molten polymer to transition to the crystalline state at a higher temperature (e.g., increased Tmc).

In an embodiment, the poly(arylene sulfide) polymer composition can be characterized by an injection molding cycle time that is reduced by at least about 5%, alternatively reduced by about 10%, or alternatively reduced by about 15%, when compared to an injection molding cycle time of the neat poly(arylene sulfide) polymer from which the poly(arylene sulfide) polymer composition was formed. Without wishing to be limited by theory, an increased Tmc can lead to a decreased injection molding cycle time, as a molten polymer needs less time to reach a higher Tmc when cooling down to form a molded article.

In an embodiment, a process for producing a poly(arylene sulfide) polymer can comprise the steps of (a) reacting a sulfur source and a dihaloaromatic compound in the presence of a polar organic compound to form a poly(arylene sulfide) reaction mixture; (b) washing at least a portion of the poly(arylene sulfide) reaction mixture with a polar organic compound solvent mixture and/or water to obtain a poly(arylene sulfide) polymer composition and a first slurry, wherein the polar organic compound solvent mixture has a temperature of from about 25° C. to about 275° C., and wherein the polar organic compound is present in the polar organic compound solvent mixture in an amount of from about 100 vol. % to about 25 vol. %, based on the total volume of the polar organic compound solvent mixture; (c) optionally treating at least a portion of the poly(arylene sulfide) polymer composition with an aqueous acid solution and/or an aqueous metal cation solution to obtain a treated poly(arylene sulfide) polymer composition; and (d) drying at least a portion of the poly(arylene sulfide) polymer composition and/or treated poly(arylene sulfide) polymer composition to obtain a dried poly(arylene sulfide) polymer composition; wherein the poly(arylene sulfide) polymer composition can comprise a poly(arylene sulfide) polymer and a cyclic oligomer nucleating agent; and wherein the poly(arylene sulfide) polymer composition can comprise the cyclic oligomer nucleating agent in an amount of from about 2,500 ppmw (0.25 wt. %) to about 13,000 ppmw (1.3 wt. %), alternatively from about 3,000 ppmw (0.3 wt. %) to about 12,500 ppmw (1.25 wt. %), or alternatively from about 3,500 ppmw (0.35 wt. %) to about 12,000 ppmw (1.2 wt. %), based on the total weight of the poly(arylene sulfide) polymer composition. In such embodiment, the poly(arylene sulfide) polymer composition can be characterized by a Tmc that is greater by at least about 5° C. than a Tmc of an otherwise similar poly(arylene sulfide) polymer composition produced in the absence of step (b) washing at least a portion of the poly(arylene sulfide) reaction mixture with a polar organic compound solvent mixture and/or water. In such embodiment, the polar organic compound solvent mixture can comprise N-methyl-2-pyrrolidone and water.

In an embodiment (and in addition to and/or as an alternative to various embodiments where a neat poly(arylene sulfide) polymer is contacted or combined with a cyclic oligomer nucleating agent), a poly(arylene sulfide) polymer composition can be obtained by modifying one or more process parameters (e.g., temperature, solution concentration, etc.) for at least one step of the process for producing a poly(arylene sulfide) polymer, such that a recovered polymer end product comprises a poly(arylene sulfide) polymer composition (as opposed to a neat poly(arylene sulfide) polymer). In such embodiment, modifying one or more process parameters for at least one step of the process for producing a poly(arylene sulfide) polymer can increase a concentration of the cyclic oligomer nucleating agent in the recovered polymer end product, wherein the recovered polymer end product comprises a poly(arylene sulfide) polymer composition (as opposed to a neat poly(arylene sulfide) polymer) having amounts of the cyclic oligomer nucleating agent as described herein. In other words, in contrast to modifying or adjusting an amount of cyclic oligomer nucleating agent initially present in a neat poly(arylene sulfide) polymer (e.g., a starting amount) by combining the neat poly(arylene sulfide) polymer with an additional, adjusting, or additive amount (e.g., about 0.25 wt. % to about 1 wt. %) of cyclic oligomer nucleating agent to produce a poly(arylene sulfide) polymer composition having a final or target amount of cyclic oligomer nucleating agent as described herein, one or more process conditions of the polymerization process can be modified such that the polymer produced by and recovered from the polymerization process is the poly(arylene sulfide) polymer composition having a final or target amount of cyclic oligomer nucleating agent as described herein.

In an embodiment, one or more process parameters of a step of washing at least a portion of the poly(arylene sulfide) reaction mixture can be modified to yield a recovered polymer end product comprising a poly(arylene sulfide) polymer composition. In an embodiment, a process for producing a poly(arylene sulfide) polymer composition can comprise a step of washing at least a portion of the poly(arylene sulfide) reaction mixture with a polar organic compound solvent mixture and/or water to obtain a poly(arylene sulfide) polymer composition and a first slurry, wherein the polar organic compound solvent mixture can have a temperature of from about 25° C. to about 275° C., alternatively from about 35° C. to about 250° C., or alternatively from about 50° C. to about 225° C., and wherein the polar organic compound can be present in the polar organic compound solvent mixture in an amount of from about 100 vol. % to about 25 vol. %, alternatively from about 90 vol. % to about 30 vol. %, or alternatively from about 80 vol. % to about 35 vol. %, based on the total volume of the polar organic compound solvent mixture.

In an embodiment, a washing vessel can receive at least a portion of the poly(arylene sulfide) reaction mixture (e.g., the poly(arylene sulfide) reaction mixture can be introduced to a washing vessel), wherein the poly(arylene sulfide) reaction mixture can be washed with a polar organic compound solvent mixture and/or water (e.g., simultaneously or sequentially) to obtain a poly(arylene sulfide) polymer composition and a first slurry. As will be appreciated by one of skill in the art, more than one washing vessel can be used for washing the poly(arylene sulfide) reaction mixture, such as for example two, three, four, five, six, or more washing vessels can be used for washing the poly(arylene sulfide) reaction mixture.

In an embodiment, the polar organic compound solvent mixture can comprise a polar organic compound and water. For example, a polar organic compound solvent mixture comprising 25 vol. % polar organic compound can also comprise 75 vol. % water.

In an embodiment, the polar organic compound of the polar organic compound solvent mixture can comprise any of the polar organic compounds previously disclosed herein, such as for example NMP. In some embodiments, the polar organic compound of the polar organic compound solvent mixture can further comprise dimethyl sulfoxide (DMSO), N,N-dimethylformamide (DMF), acetone, and the like, or combinations thereof.

Once the poly(arylene sulfide) polymer composition has precipitated from solution, a particulate poly(arylene sulfide) polymer composition can be separated (e.g., recovered, retrieved, obtained, etc.) from the poly(arylene sulfide) reaction mixture (e.g., poly(arylene sulfide) reaction mixture slurry) by any process capable of separating a solid precipitate from a liquid. For purposes of the disclosure herein, the particulate poly(arylene sulfide) polymer composition separated from the poly(arylene sulfide) reaction mixture will be referred to as “poly(arylene sulfide) polymer composition particles,” “poly(arylene sulfide) composition particles,” “particulate poly(arylene sulfide) polymer composition,” “particulate poly(arylene sulfide) composition,” “poly(arylene sulfide) polymer composition,” or simply “poly(arylene sulfide) composition.”

In an embodiment, the particulate poly(arylene sulfide) polymer composition can undergo the same processing steps as previously described herein for the particulate poly(arylene sulfide) polymer (e.g., neat particulate poly(arylene sulfide) polymer), such as for example (i) treating at least a portion of the poly(arylene sulfide) polymer composition with an aqueous acid solution and/or an aqueous metal cation solution to obtain a treated poly(arylene sulfide) polymer composition and a waste aqueous solution; (ii) drying at least a portion of the poly(arylene sulfide) polymer composition and/or treated poly(arylene sulfide) polymer composition to obtain a dried poly(arylene sulfide) polymer composition; (iii) curing the poly(arylene sulfide) polymer composition; (iv) melt processing the poly(arylene sulfide) polymer composition; etc.

In an embodiment, the poly(arylene sulfide) polymer composition obtained by washing at least a portion of the poly(arylene sulfide) reaction mixture with a polar organic compound solvent mixture and/or water can comprise a poly(arylene sulfide) polymer and a cyclic oligomer nucleating agent, wherein the poly(arylene sulfide) polymer composition comprises the cyclic oligomer nucleating agent in an amount of from about 2,500 ppmw (0.25 wt. %) to about 13,000 ppmw (1.3 wt. %), alternatively from about 3,000 ppmw (0.3 wt. %) to about 12,500 ppmw (1.25 wt. %), or alternatively from about 3,500 ppmw (0.35 wt. %) to about 12,000 ppmw (1.2 wt. %), based on the total weight of the poly(arylene sulfide) polymer composition. In an embodiment, a neat poly(arylene sulfide) polymer (e.g., where the neat poly(arylene sulfide) polymer is produced by an unmodified polymerization process, that is in the absence of a step of washing at least a portion of the poly(arylene sulfide) reaction mixture with a polar organic compound solvent mixture and/or water) comprises the cyclic oligomer nucleating agent in an amount of less than about 3,000 ppmw (0.3 wt. %), alternatively less than about 2,500 ppmw (0.25 wt. %), or alternatively less than about 2,000 ppmw (0.2 wt. %), based on the total weight of the neat poly(arylene sulfide) polymer.

In an embodiment, the amount of cyclic oligomer nucleating agent present in a polymer (e.g., a starting amount present in a neat poly(arylene sulfide) polymer and/or a target amount present in a poly(arylene sulfide) polymer composition) can be monitored by using any suitable analytical technique, such as for example, extraction techniques, chromatography, gas chromatography, gel permeation chromatography (GPC), mass spectrometry, matrix-assisted laser desorption/ionization/time-of-flight (MALDI-TOF), and the like, or combinations thereof.

In an embodiment, the poly(arylene sulfide) polymer composition obtained by washing at least a portion of the poly(arylene sulfide) reaction mixture with a polar organic compound solvent mixture and/or water can be characterized by a Tmc that is greater by at least about 5° C., alternatively greater by about 10° C., or alternatively greater by about 15° C., than a Tmc of an otherwise similar poly(arylene sulfide) polymer composition produced in the absence of a step of washing at least a portion of the poly(arylene sulfide) reaction mixture with a polar organic compound solvent mixture and/or water.

In an embodiment, the poly(arylene sulfide) polymer composition obtained by washing at least a portion of the poly(arylene sulfide) reaction mixture with a polar organic compound solvent mixture and/or water can be characterized by a Tmc that is greater by at least about 5° C., alternatively greater by about 10° C., or alternatively greater by about 15° C., than a Tmc of a neat poly(arylene sulfide) polymer.

In an embodiment, a poly(phenylene sulfide) (PPS) polymer composition can comprise a neat PPS polymer and a cyclic oligomer nucleating agent characterized by Structure I:

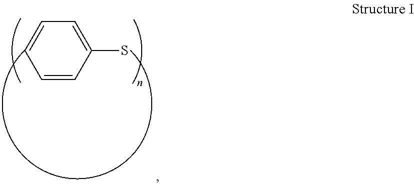

wherein n is equal to 6, n is equal to 8, or combinations thereof; wherein the cyclic oligomer nucleating agent is contacted with the neat PPS polymer in an amount of from about 0.25 wt. % to about 1 wt. % cyclic oligomer nucleating agent, based on the total weight of the PPS polymer composition; and wherein the PPS polymer composition is characterized by a Tmc that is greater by at least about 5° C. than a Tmc of the neat PPS polymer. In an embodiment, the neat PPS polymer can be prepared by reacting a sulfur source and p-dichlorobenzene in the presence of N-methyl-2-pyrrolidone (NMP). In an embodiment, the neat PPS polymer can be an acid treated PPS polymer.

In an embodiment, a PPS polymer composition can comprise a neat PPS and a cyclic oligomer nucleating agent characterized by Structure I:

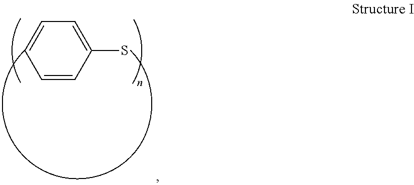

wherein n is equal to 6, n is equal to 8, or combinations thereof; wherein the neat PPS polymer comprises the cyclic oligomer nucleating agent in an amount of less than about 3,000 ppmw (0.3 wt. %), based on the total weight of the neat PPS polymer; wherein the PPS polymer composition comprises the cyclic oligomer nucleating agent in an amount of from about 2,500 ppmw (0.25 wt. %) to about 13,000 ppmw (1.3 wt. %), based on the total weight of the PPS polymer composition; and wherein the PPS polymer composition is characterized by a Tmc that is greater by at least about 5° C. than a Tmc of the neat PPS polymer. In an embodiment, the neat PPS polymer can be a metal cation treated PPS polymer.

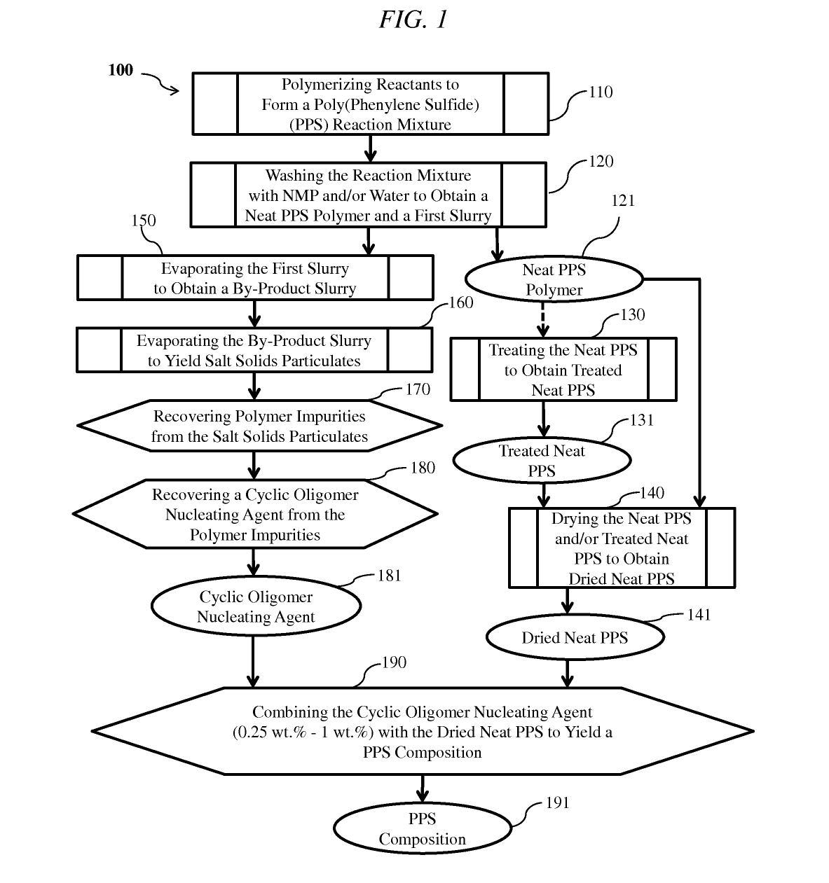

Referring to the embodiment of FIG. 1, a process 100 for producing a PPS polymer composition is illustrated. The process 100 for producing a PPS polymer composition can generally comprise (a) a step 110 of polymerizing reactants (e.g., reacting a sulfur source and p-dichlorobenzene in the presence of NMP) to form a PPS reaction mixture; (b) a step 120 of washing at least a portion of the PPS reaction mixture with NMP and/or water to obtain a neat PPS polymer 121 and a first slurry; (c) a step 130 of optionally treating at least a portion of the neat PPS polymer 121 with an aqueous acid solution and/or an aqueous metal cation solution to obtain a treated neat PPS polymer 131; (d) a step 140 of drying at least a portion of the neat PPS polymer 121 and/or treated neat PPS polymer 131 to obtain a dried neat PPS polymer 141; (e) a step 150 of evaporating a portion of the first slurry to obtain a by-product slurry; (f) a step 160 of removing at least a portion of the NMP and/or water from the by-product slurry (e.g., evaporating at least a portion of the by-product slurry) to yield salt solids particulates, wherein the salt solids particulates comprise NaCl and polymer impurities; (g) a step 170 of recovering at least a portion of the polymer impurities from the salt solids particulates, wherein the polymer impurities comprise a cyclic oligomer nucleating agent; (h) a step 180 of recovering at least a portion of the cyclic oligomer nucleating agent 181 from the polymer impurities; and (i) a step 190 of combining at least a portion of the cyclic oligomer nucleating agent 181 with at least a portion of the dried neat PPS polymer 141 to yield a PPS polymer composition 191, wherein the cyclic oligomer nucleating agent 181 is contacted with the neat PPS polymer 141 in an amount of from about 0.25 wt. % to about 1 wt. % cyclic oligomer nucleating agent, based on the total weight of the PPS polymer composition.

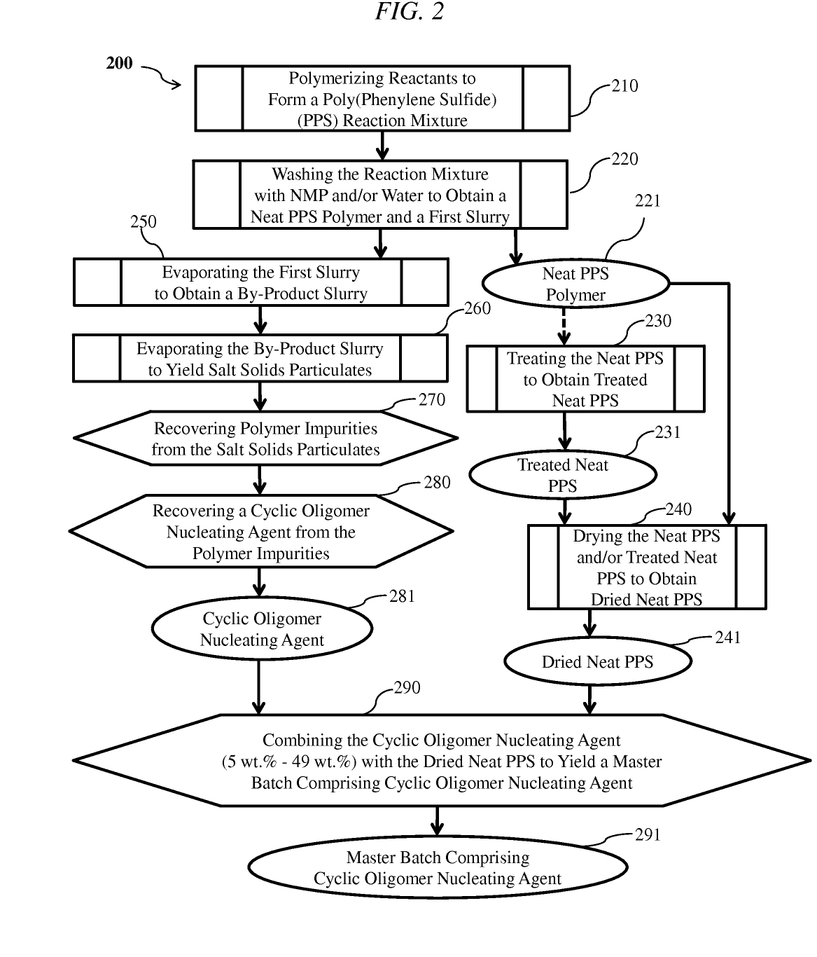

Referring to the embodiment of FIG. 2, a process 200 for producing a master batch comprising the cyclic oligomer nucleating agent is illustrated. The process 200 for producing a master batch comprising the cyclic oligomer nucleating agent can generally comprise (a) a step 210 of polymerizing reactants (e.g., reacting a sulfur source and p-dichlorobenzene in the presence of NMP) to form a PPS reaction mixture; (b) a step 220 of washing at least a portion of the PPS reaction mixture with NMP and/or water to obtain a neat PPS polymer 221 and a first slurry; (c) a step 230 of optionally treating at least a portion of the neat PPS polymer 221 with an aqueous acid solution and/or an aqueous metal cation solution to obtain a treated neat PPS polymer 231; (d) a step 240 of drying at least a portion of the neat PPS polymer 221 and/or treated neat PPS polymer 231 to obtain a dried neat PPS polymer 241; (e) a step 250 of evaporating a portion of the first slurry to obtain a by-product slurry; (f) a step 260 of removing at least a portion of the NMP and/or water from the by-product slurry (e.g., evaporating at least a portion of the by-product slurry) to yield salt solids particulates, wherein the salt solids particulates comprise NaCl and polymer impurities; (g) a step 270 of recovering at least a portion of the polymer impurities from the salt solids particulates, wherein the polymer impurities comprise a cyclic oligomer nucleating agent; (h) a step 280 of recovering at least a portion of the cyclic oligomer nucleating agent 281 from the polymer impurities; and (i) a step 290 of combining at least a portion of the cyclic oligomer nucleating agent 281 with at least a portion of the dried neat PPS polymer 241 to yield a master batch comprising the cyclic oligomer nucleating agent 291, wherein the cyclic oligomer nucleating agent 281 is contacted with the neat PPS polymer 241 in an amount of from about 5 wt. % to about 49 wt. % cyclic oligomer nucleating agent, based on the total weight of the master batch comprising the cyclic oligomer nucleating agent. The master batch comprising the cyclic oligomer nucleating agent 291 can be further processed, for example extruded into master batch pellets suitable for use in article-forming processes. In an embodiment, the master batch comprising the cyclic oligomer nucleating agent 291 can be further combined with the neat PPS polymer 241 to yield a PPS polymer composition, wherein the PPS polymer composition comprises a cyclic oligomer nucleating agent in an amount of from about 2,500 ppmw (0.25 wt. %) to about 13,000 ppmw (1.3 wt. %), based on the total weight of the PPS polymer composition. In an embodiment, the master batch comprising the cyclic oligomer nucleating agent 291 can be further combined with any suitable PPS polymer to yield a PPS polymer composition (e.g., for example by an end user such as an injection molding company where the master batch comprising the cyclic oligomer nucleating agent is contacted with a PPS polymer (e.g., a neat or raw polymer) in an extruding process to form the PPS polymer composition), wherein the PPS polymer composition comprises a cyclic oligomer nucleating agent in an amount of from about 2,500 ppmw (0.25 wt. %) to about 13,000 ppmw (1.3 wt. %), based on the total weight of the PPS polymer composition.

In an embodiment, a master batch comprising the cyclic oligomer nucleating agent can comprise a neat PPS polymer and a cyclic oligomer nucleating agent, wherein the cyclic oligomer nucleating agent is contacted with the neat PPS polymer in an amount of from about 5 wt. % to about 49 wt. % cyclic oligomer nucleating agent, based on the total weight of the master batch comprising the cyclic oligomer nucleating agent.

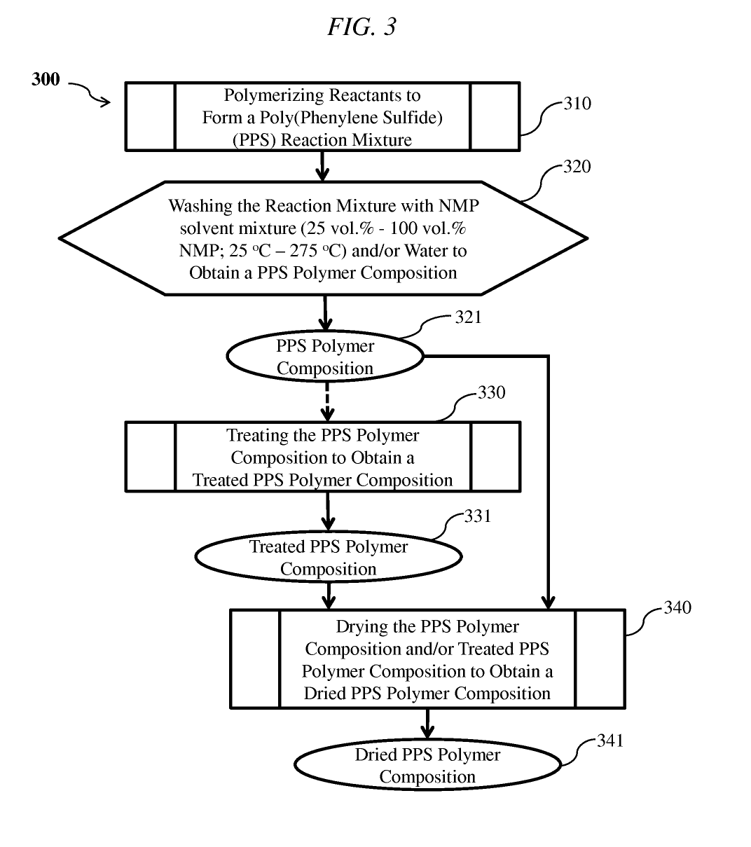

Referring to the embodiment of FIG. 3, a process 300 for producing a poly(phenylene sulfide) (PPS) polymer composition is illustrated. The process 300 for producing a PPS polymer composition can generally comprise (a) a step 310 of polymerizing reactants (e.g., reacting a sulfur source and p-dichlorobenzene in the presence of NMP) to form a PPS reaction mixture; (b) a step 320 of washing at least a portion of the PPS reaction mixture with a NMP solvent mixture and/or water to obtain a PPS polymer composition 321 and a first slurry, wherein the NMP solvent mixture has a temperature of from about 25° C. to about 275° C., and wherein NMP is present in the NMP solvent mixture in an amount of from about 100 vol. % to about 25 vol. %, based on the total volume of the NMP solvent mixture; a step 330 of optionally treating at least a portion of the PPS polymer composition 321 with an aqueous acid solution and/or an aqueous metal cation solution to obtain a treated PPS polymer composition 331; and (d) a step 340 of drying at least a portion of the PPS polymer composition 321 and/or treated PPS polymer composition 331 to obtain a dried PPS polymer composition 341; wherein the PPS polymer composition 341 comprises a PPS polymer and a cyclic oligomer nucleating agent; and wherein the cyclic oligomer nucleating agent is present in the PPS polymer composition 341 in an amount of from about 2,500 ppmw (0.25 wt. %) to about 13,000 ppmw (1.3 wt. %), based on the total weight of the PPS polymer composition 341. In an embodiment, an otherwise similar PPS polymer composition (e.g., a neat PPS polymer) produced in the absence of step 320 of washing at least a portion of the PPS reaction mixture with a NMP solvent mixture and/or water can comprise the cyclic oligomer nucleating agent in an amount of less than about 3,000 ppmw (0.3 wt. %), based on the total weight of the otherwise similar PPS polymer composition (e.g., the neat PPS polymer). In such embodiment, the PPS polymer composition 341 can be characterized by a melt crystallization temperature (Tmc) that is greater by at least about 5° C. than a Tmc of an otherwise similar PPS polymer composition (e.g., a neat PPS polymer) produced in the absence of step 320 of washing at least a portion of the PPS reaction mixture with a NMP solvent mixture and/or water.

In an embodiment, a process of producing a PPS polymer article can generally comprise the steps of (i) melting a PPS polymer composition to yield a molten PPS polymer composition, wherein the PPS polymer composition comprises a neat PPS polymer and a cyclic oligomer nucleating agent, and wherein the cyclic oligomer nucleating agent is contacted with the neat PPS polymer in an amount of from about 0.25 wt. % to about 1 wt. % cyclic oligomer nucleating agent, based on the total weight of the PPS polymer composition; and (ii) injection molding the molten PPS polymer composition to yield the PPS polymer article, wherein a cycle time of injection molding the PPS polymer composition is reduced by at least about 5% when compared to a cycle time of injection molding the neat PPS polymer. In such embodiment, the process of producing a PPS polymer article can further comprise contacting the molten PPS polymer composition with polymers, fillers, fibers, reinforcing materials, pigments, nucleating agents, antioxidants, ultraviolet stabilizers, ultraviolet absorbers, lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof. In some embodiments, the cyclic oligomer nucleating agent can be added to the neat PPS polymer via a master batch during step (i).

In an embodiment, poly(arylene sulfide) polymer compositions as disclosed herein advantageously display improvements in one or more polymer characteristics when compared to an otherwise similar poly(arylene sulfide) polymer (e.g., a neat poly(arylene sulfide) polymer) lacking a cyclic oligomer nucleating agent in an amount of from about 2,500 ppmw (0.25 wt. %) to about 13,000 ppmw (1.3 wt. %), based on the total weight of the otherwise similar poly(arylene sulfide) polymer (e.g., the neat poly(arylene sulfide) polymer). For example, the poly(arylene sulfide) polymer compositions as disclosed herein can advantageously display an increased Tmc and consequently a decreased injection molding cycle time, when compared to a neat poly(arylene sulfide) polymer.

In an embodiment, the process for producing a poly(arylene sulfide) polymer as disclosed herein advantageously displays improvements in one or more process characteristics when compared to an otherwise similar process in the absence of a step of washing at least a portion of a poly(arylene sulfide) reaction mixture with a polar organic compound solvent mixture and/or water to obtain a poly(arylene sulfide) polymer composition. For example, the process for producing a poly(arylene sulfide) polymer as disclosed herein can yield a poly(arylene sulfide) polymer composition, while an otherwise similar process in the absence of a step of washing at least a portion of a poly(arylene sulfide) reaction mixture with a polar organic compound solvent mixture and/or water can lead to a neat poly(arylene sulfide) polymer, wherein the poly(arylene sulfide) polymer composition advantageously displays improved melt processing characteristics (e.g., increased Tmc, decreased injection molding cycle time) when compared with the neat poly(arylene sulfide) polymer.

Additional advantages of the poly(arylene sulfide) polymer compositions and processes of producing same as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

The effect of a cyclic oligomer nucleating agent on a neat poly(phenylene sulfide) (PPS) polymer was studied. More specifically, the effect of the amount of a cyclic oligomer nucleating agent added to a neat PPS polymer on the melt crystallization temperature (Tmc) of the polymer was investigated. Neat PPS was prepared by using general reaction conditions (e.g., reaction cycle, stoichiometry, etc.) previously described herein.

For example, neat PPS can be prepared according to the following recipe describing an example of a reaction cycle. To a 1-liter titanium reactor was added 0.666 mole of NaSH (62.50 grams), 0.680 mole of NaOH (27.61 grams), and 1.665 moles of N-methyl-2-pyrrolidone (NMP; 165.05 grams). The reactor was closed and the reactor stirrer operated at 175 revolutions per minute. The reactor was purged of air by charging the reactor with nitrogen to 50 psig and then depressurizing the reactor five consecutive times, and then charging the reactor with nitrogen to 200 psig and then depressurizing the reactor five consecutive times. Water was then removed (also referred to as dehydration) from the reactor by heating the reactor to approximately 140° C. The dehydration line was then opened, a nitrogen flow rate of 32 cc/minute was introduced into the reactor, and the reactor was heated to approximately 200° C. over a period of 95 minutes. During this time 25 mL of liquid was collected. Gas chromatography of the collected liquid indicated that the collected liquid contained 96 weight % water and 4.0 weight % NMP. Upon completion of the dehydration, the dehydration line was closed, the reactor was charged to 50 psig with nitrogen, and the nitrogen flow was discontinued. The reactor was then heated to 250° C. To a 0.3 liter charging vessel was added 0.666 mole of para-dichlorobenzene (98.0 grams) and 0.25 mole of NMP (25.0 grams). The charging vessel was then purged with nitrogen, closed, and placed in a heated bath (at approximately 100° C.) until it was to be charged to the reactor. When the reactor reached 250° C., the contents of the charging vessel were then pressured (nitrogen pressure) into the reactor. The charging vessel was rinsed with 0.5 mole of NMP (49.56 grams) and the rinse was pressured (nitrogen pressure) into the reactor. Once the contents of the charging vessel were charged to the reactor, the reactor temperature was increased to 250° C. and was maintained at 250° C. for approximately four hours. The reaction mixture was flashed to obtain a flash resin (e.g., flash PPS, isolated flash PPS).

A cyclic oligomer nucleating agent was isolated from the flash PPS by using the following procedure. The cyclic oligomers were removed by heating (e.g., steam jacket) the isolated flash PPS in NMP with stirring to yield a flash PPS solution. The flash PPS solution was filtered to produce a filtrate comprising a nucleating agent solution. The NMP was removed from the nucleating agent solution, and water was added to facilitate precipitation of the cyclic oligomer nucleating agent, which was further isolated to yield the cyclic oligomer nucleating agent.

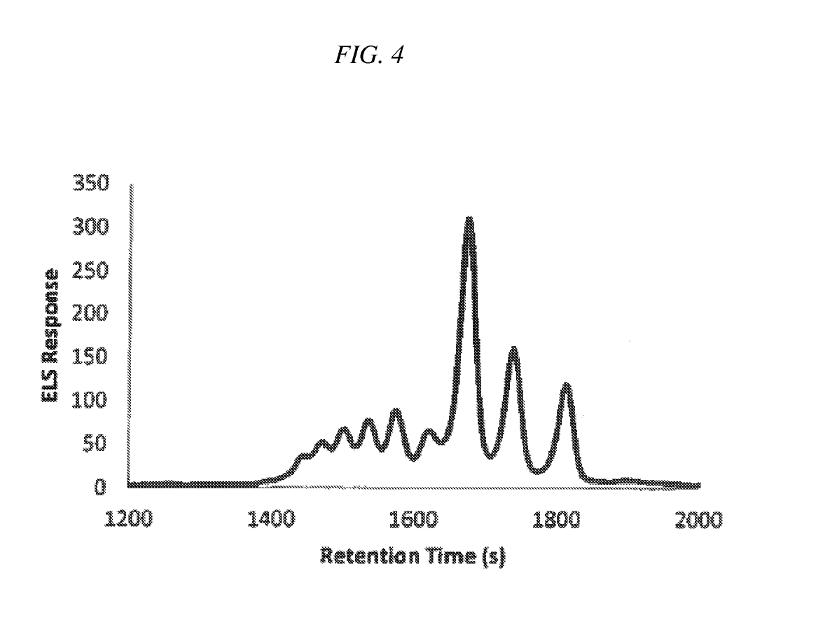

The cyclic oligomer nucleating agent was analyzed by gel permeation chromatography (GPC) by solubilizing the cyclic oligomer nucleating agent in 1,2,4-trichlorobenzene (TCB) at 135° C. Generally, 10 mg of cyclic oligomer nucleating agent was dissolved in 10 mL of TCB. GPC analysis was conducted on a Polymer Labs PL-GPC220 high temperature GPC unit at 125° C. using 1,2,4-trichlorobenzene as the mobile phase on Agilent oligopore columns. Detection was accomplished using a Polymer Labs ELS-1000 evaporative light scattering (ELS) detector. The GPC trace of the cyclic oligomer nucleating agent is displayed in FIG. 4. The GPC trace of FIG. 4 shows the different molecular weights present in the cyclic oligomer sample and the relative quantities of each. The GPC traces could be further correlated with matrix-assisted laser desorption/ionization/time-of-flight (MALDI-TOF) data to provide for molecular weight data for the cyclic oligomer nucleating agent.

Various amounts of the cyclic oligomer nucleating agent were mixed with the neat PPS polymer, and the Tmc of each sample was recorded. A desired amount of the cyclic oligomer nucleating agent was mixed with a desired amount of neat PPS polymer in a plastic bag to yield a total amount of material of from about 5 grams to about 10 grams, followed by vigorous manual shaking for 2-3 minutes. This was done to ensure good dispersion of the cyclic oligomer nucleating agent throughout the host matrix (e.g., neat PPS). The mixed materials were then extruded using a DACA micro-compounder/extruder (Model 20000) to blend the nucleating agent with the neat PPS polymer. The system was set to 305° C. for all cyclic oligomer nucleating agent samples. The screw speed was set to 100 rpm. Generally, the material was allowed to compound/recycle for 2-3 minutes before extruding.

The compounded materials were then analyzed by differential scanning calorimetry (DSC) to see if crystallization kinetics had been altered by the incorporation of the cyclic oligomer nucleating agent. For each test, a control sample of neat PPS was extruded under the same conditions and analyzed by DSC to provide values for Tmc, melting point (Tₘ) and glass-transition temperature (T_{g}). DSC analysis was conducted on a TA Instruments Q100 differential scanning calorimeter. Samples were heated at a 10° C./min ramp rate and held at 350° C. for 10 min before cooling. All reported values are from the second heating cycle.

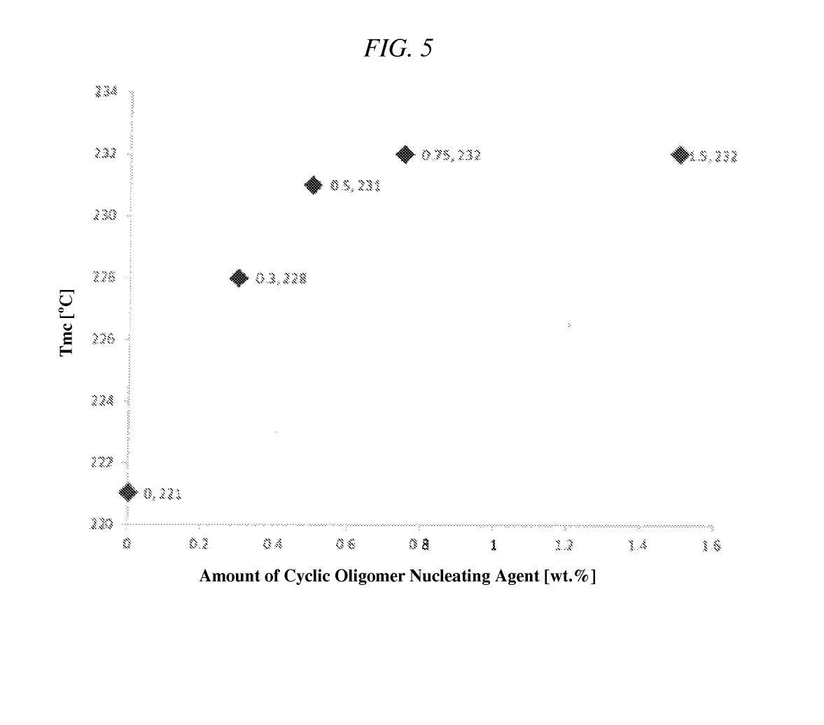

In order to explore the sensitivity of the Tmc of the polymer to the incorporation of cyclic oligomer nucleating agent, a series of PPS polymer composition samples with a content of 0.3 wt. %, 0.5 wt. %, 0.75 wt. %, and 1.5 wt. % cyclic oligomer nucleating agent were prepared and tested, and the data are displayed in FIG. 5. A gradual increase in the Tmc was observed for a cyclic oligomer nucleating agent content of up to 0.75 wt. %. The dramatic increase in Tmc for a cyclic oligomer nucleating agent content of 0.3 wt. % was unexpected. The cyclic oligomer nucleating agent content of 1.5 wt. % resulted in a Tmc increase of 10° C. The data in FIG. 5 indicate that the cyclic oligomer nucleating agents have nucleation or nucleating inducing capabilities similar to high melting polyarylether ketone materials.

Further, when a neat calcium washed PPS polymer was mixed with 1.5 wt. % cyclic oligomer nucleating agent content, an increase in Tmc of 9° C. (from 189° C. to 198° C.) was observed. A neat PPS polymer was obtained via a quench termination process. To obtain the neat calcium washed PPS polymer, the following procedure was followed: the reaction mixture obtained from the 1-liter reactor was removed after polymerization. 2 L of NMP were added to the reaction mixture and a resulting slurry mixture was stirred at 90° C. for 45 minutes. Filtration of the slurry mixture provided an isolated neat PPS material with most of the cyclic oligomer nucleating agent removed. 2 L of water were added to the isolated neat PPS, which was then stirred at 90° C. for 45 minutes and filtered to isolate PPS particles/solids (e.g., neat PPS particles). The neat PPS particles were washed in this manner 6 more times. Then, the neat PPS particles were washed with 2 L of a calcium acetate solution (0.2 g/L) at 90° C. to yield the neat calcium washed PPS polymer. The neat calcium washed PPS polymer was collected by filtration and dried in a vacuum oven at 50° C. overnight.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

The following enumerated embodiments are provided as non-limiting examples.

A first embodiment, which is a poly(arylene sulfide) polymer composition comprising a neat poly(arylene sulfide) polymer and a cyclic oligomer nucleating agent;

wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and wherein the poly(arylene sulfide) polymer composition is characterized by a melt crystallization temperature (Tmc) that is greater by at least about 5° C. than a Tmc of the neat poly(arylene sulfide) polymer.

A second embodiment, which is a poly(arylene sulfide) polymer composition comprising a neat poly(arylene sulfide) polymer and a cyclic oligomer nucleating agent;

wherein the neat poly(arylene sulfide) polymer comprises the cyclic oligomer nucleating agent in an amount of less than about 3,000 ppmw, based on the total weight of the neat poly(arylene sulfide) polymer;

wherein the poly(arylene sulfide) polymer composition comprises the cyclic oligomer nucleating agent in an amount of from about 2,500 ppmw to about 13,000 ppmw, based on the total weight of the poly(arylene sulfide) polymer composition; and

wherein the poly(arylene sulfide) polymer composition is characterized by a melt crystallization temperature (Tmc) that is greater by at least about 5° C. than a Tmc of the neat poly(arylene sulfide) polymer.

A third embodiment, which is the polymer composition of the first embodiment, wherein the cyclic oligomer nucleating agent comprises a compound characterized by Structure I:

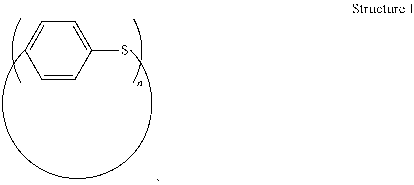

wherein n is from 4 to 12.

A fourth embodiment, which is the polymer composition of the third embodiment, wherein the polymer composition comprises a cyclic oligomer nucleating agent characterized by Structure I, wherein n is equal to 6, n is equal to 8, or combinations thereof.

A fifth embodiment, which is the polymer composition of any of the first through the fourth embodiments, wherein the cyclic oligomer nucleating agent is characterized by a weight average molecular weight of from about 400 kg/mol to about 1,500 kg/mol.

A sixth embodiment, which is the polymer composition of any of the first through the fifth embodiments, wherein the cyclic oligomer nucleating agent is a by-product of a poly(arylene sulfide) polymerization reaction.

A seventh embodiment, which is the polymer composition of any of the first through the sixth embodiments, further characterized by an injection molding cycle time that is reduced by at least about 5% when compared to an injection molding cycle time of the neat poly(arylene sulfide) polymer.

An eighth embodiment, which is the polymer composition of any of the first through the seventh embodiments, wherein the neat poly(arylene sulfide) polymer is an acid treated poly(arylene sulfide) polymer.

A ninth embodiment, which is the polymer composition of any of the first through the eighth embodiments, wherein the neat poly(arylene sulfide) polymer is a metal cation treated poly(arylene sulfide) polymer.

A tenth embodiment, which is the polymer composition of any of the first through the ninth embodiments, wherein the poly(arylene sulfide) is a poly(phenylene sulfide).

An eleventh embodiment, which is the polymer composition of any of the first through the tenth embodiments, wherein the neat poly(arylene sulfide) polymer is a product of a polymerization process comprising a quench termination step.

A twelfth embodiment, which is the polymer composition of any of the first through the eleventh embodiments, wherein the neat poly(arylene sulfide) polymer is prepared by reacting a sulfur source and a dihaloaromatic compound in the presence of a polar organic compound.

A thirteenth embodiment, which is the polymer composition of any of the first through the twelfth embodiments being prepared by: (i) isolating a cyclic oligomer nucleating agent from a polymer production process; and (ii) contacting the isolated cyclic oligomer nucleating agent with the neat poly(arylene sulfide) polymer.

A fourteenth embodiment, which is the polymer composition of any of the first through the thirteenth embodiments being prepared by combining a master batch comprising the cyclic oligomer nucleating agent with the neat poly(arylene sulfide) polymer.

A fifteenth embodiment, which is an additive pack comprising the cyclic oligomer nucleating agent of the third embodiment.

A sixteenth embodiment, which is the additive pack of the fifteenth embodiment further comprising polymers, fillers, fibers, reinforcing materials, pigments, nucleating agents, antioxidants, ultraviolet stabilizers, ultraviolet absorbers, lubricants, fire retardants, heat stabilizers, carbon black, plasticizers, corrosion inhibitors, mold release agents, pigments, titanium dioxide, clay, mica, processing aids, adhesives, tackifiers, or combinations thereof.

A seventeenth embodiment, which is the additive pack of any of the fifteenth through the sixteenth embodiments, wherein the cyclic oligomer nucleating agent is in powder form.

An eighteenth embodiment, which is an additive pack comprising the master batch comprising the cyclic oligomer nucleating agent of the fourteenth embodiment.

A nineteenth embodiment which is an additive pack of the eighteenth embodiment, wherein the master batch comprising the cyclic oligomer nucleating agent comprises pellets.

A twentieth embodiment which is the polymer composition of any of the first through the nineteenth embodiments, wherein the neat poly(arylene sulfide) polymer comprises less than about 3,000 ppmw cyclic oligomer nucleating agent, based on the total weight of the neat poly(arylene sulfide) polymer.

A twenty-first embodiment, which is a process for producing a poly(arylene sulfide) polymer composition comprising:

(a) reacting a sulfur source and a dihaloaromatic compound in the presence of a polar organic compound to form a poly(arylene sulfide) reaction mixture;

(b) washing at least a portion of the poly(arylene sulfide) reaction mixture with a polar organic compound solvent mixture and/or water to obtain a poly(arylene sulfide) polymer composition and a first slurry, wherein the polar organic compound solvent mixture has a temperature of from about 25° C. to about 275° C., and wherein the polar organic compound is present in the polar organic compound solvent mixture in an amount of from about 100 vol. % to about 25 vol. %, based on the total volume of the polar organic compound solvent mixture;

(c) optionally treating at least a portion of the poly(arylene sulfide) polymer composition with an aqueous acid solution and/or an aqueous metal cation solution to obtain a treated poly(arylene sulfide) polymer composition; and

(d) drying at least a portion of the poly(arylene sulfide) polymer composition and/or treated poly(arylene sulfide) polymer composition to obtain a dried poly(arylene sulfide) polymer composition;

wherein the poly(arylene sulfide) polymer composition comprises a poly(arylene sulfide) polymer and a cyclic oligomer nucleating agent; and

wherein the poly(arylene sulfide) polymer composition comprises the cyclic oligomer nucleating agent in an amount of from about 2,500 ppmw to about 13,000 ppmw, based on the total weight of the poly(arylene sulfide) polymer composition.

A twenty-second embodiment, which is a process for producing a poly(arylene sulfide) polymer composition comprising:

(a) reacting a sulfur source and a dihaloaromatic compound in the presence of a polar organic compound to form a poly(arylene sulfide) reaction mixture;

(b) washing at least a portion of the poly(arylene sulfide) reaction mixture with a polar organic compound solvent mixture and/or water to obtain a poly(arylene sulfide) polymer composition and a first slurry, wherein the polar organic compound solvent mixture has a temperature of from about 25° C. to about 275° C., and wherein the polar organic compound is present in the polar organic compound solvent mixture in an amount of from about 100 vol. % to about 25 vol. %, based on the total volume of the polar organic compound solvent mixture;

(c) optionally treating at least a portion of the poly(arylene sulfide) polymer composition with an aqueous acid solution and/or an aqueous metal cation solution to obtain a treated poly(arylene sulfide) polymer composition; and

(d) drying at least a portion of the poly(arylene sulfide) polymer composition and/or treated poly(arylene sulfide) polymer composition to obtain a dried poly(arylene sulfide) polymer composition; and

wherein the poly(arylene sulfide) polymer composition is characterized by a melt crystallization temperature (Tmc) that is greater by at least about 5° C. than a Tmc of an otherwise similar poly(arylene sulfide) polymer composition produced in the absence of step (b) washing at least a portion of the poly(arylene sulfide) reaction mixture with a polar organic compound solvent mixture and/or water.

A twenty-third embodiment, which is the process of the twenty-first embodiment, wherein the polar organic compound solvent mixture comprises a polar organic compound and water.

A twenty-fourth embodiment, which is the process of the twenty-third embodiment, wherein the polar organic compound comprises N-methyl-2-pyrrolidone.

A twenty-fifth embodiment, which is a process of producing a poly(arylene sulfide) polymer article comprising:

(i) melting a poly(arylene sulfide) polymer composition to yield a molten poly(arylene sulfide) polymer composition, wherein the poly(arylene sulfide) polymer composition comprises a neat poly(arylene sulfide) polymer and a cyclic oligomer nucleating agent, and wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and

(ii) injection molding the molten poly(arylene sulfide) polymer composition to yield the poly(arylene sulfide) polymer article, wherein a cycle time of injection molding the poly(arylene sulfide) polymer composition is reduced by at least about 5% when compared to a cycle time of injection molding the neat poly(arylene sulfide) polymer.

A twenty-sixth embodiment, which is the process of the twenty-fifth embodiment, wherein the cyclic oligomer nucleating agent is added to the neat poly(arylene sulfide) polymer via a master batch during step (i).

A twenty-seventh embodiment, which is the process of any of the twenty-fifth through the twenty-sixth embodiments further comprising contacting the molten poly(arylene sulfide) polymer composition with polymers, fillers, fibers, reinforcing materials, pigments, nucleating agents, antioxidants, ultraviolet stabilizers, ultraviolet absorbers, lubricants, fire retardants, heat stabilizers, carbon black, plasticizers, corrosion inhibitors, mold release agents, pigments, titanium dioxide, clay, mica, processing aids, adhesives, tackifiers, or combinations thereof.

A twenty-eighth embodiment, which is a poly(arylene sulfide) polymer composition prepared by contacting a neat poly(arylene sulfide) polymer and a cyclic oligomer nucleating agent; wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and wherein the poly(arylene sulfide) polymer composition is characterized by a melt crystallization temperature (Tmc) that is greater by at least about 5° C. than a Tmc of the neat poly(arylene sulfide) polymer.

A twenty-ninth embodiment, which is a poly(arylene sulfide) polymer composition prepared by contacting a neat poly(arylene sulfide) polymer and a cyclic oligomer nucleating agent; wherein the neat poly(arylene sulfide) polymer comprises the cyclic oligomer nucleating agent in an amount of less than about 3,000 ppmw (0.3 wt. %), based on the total weight of the PPS polymer; wherein the poly(arylene sulfide) polymer composition comprises the cyclic oligomer nucleating agent in an amount of from about 2,500 ppmw (0.25 wt. %) to about 13,000 ppmw (1.3 wt. %), based on the total weight of the poly(arylene sulfide) polymer composition; and wherein the poly(arylene sulfide) polymer composition is characterized by a melt crystallization temperature (Tmc) that is greater by at least about 5° C. than a Tmc of the neat poly(arylene sulfide) polymer.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A poly(arylene sulfide) polymer composition comprising a neat poly(arylene sulfide) polymer and a cyclic oligomer nucleating agent;
wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and
wherein the poly(arylene sulfide) polymer composition is characterized by a melt crystallization temperature (Tmc) that is greater by at least about 5° C. than a Tmc of the neat poly(arylene sulfide) polymer.

2. The polymer composition of claim 1, wherein the cyclic oligomer nucleating agent comprises a compound characterized by Structure I: 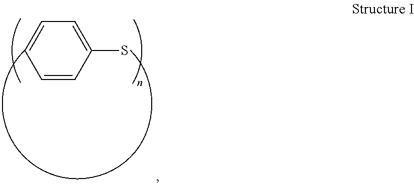
wherein n is from 4 to 12.

3. The polymer composition of claim 2, wherein the polymer composition comprises a cyclic oligomer nucleating agent characterized by Structure I, wherein n is equal to 6, n is equal to 8, or combinations thereof.

4. The polymer composition of claim 1, wherein the cyclic oligomer nucleating agent is characterized by a weight average molecular weight of from about 400 kg/mol to about 1,500 kg/mol.

5. The polymer composition of claim 1, wherein the cyclic oligomer nucleating agent is a by-product of a poly(arylene sulfide) polymerization reaction.

6. The polymer composition of claim 1 further characterized by an injection molding cycle time that is reduced by at least about 5% when compared to an injection molding cycle time of the neat poly(arylene sulfide) polymer.

7. The polymer composition of claim 1, wherein the neat poly(arylene sulfide) polymer is an acid treated poly(arylene sulfide) polymer.

8. The polymer composition of claim 1, wherein the poly(arylene sulfide) is a poly(phenylene sulfide).

9. The polymer composition of claim 1 being prepared by: (i) isolating a cyclic oligomer nucleating agent from a polymer production process; and (ii) contacting the isolated cyclic oligomer nucleating agent with the neat poly(arylene sulfide) polymer.

10. The polymer composition of claim 1 being prepared by combining a master batch comprising the cyclic oligomer nucleating agent with the neat poly(arylene sulfide) polymer.

11. An additive pack comprising the cyclic oligomer nucleating agent of claim 2.

12. The additive pack of claim 11 further comprising polymers, fillers, fibers, reinforcing materials, pigments, nucleating agents, antioxidants, ultraviolet stabilizers, ultraviolet absorbers, lubricants, fire retardants, heat stabilizers, carbon black, plasticizers, corrosion inhibitors, mold release agents, pigments, titanium dioxide, clay, mica, processing aids, adhesives, tackifiers, or combinations thereof.

13. The additive pack of claim 11, wherein the cyclic oligomer nucleating agent is in powder form.

14. An additive pack comprising the master batch comprising the cyclic oligomer nucleating agent of claim 10.

15. The additive pack of claim 14, wherein the master batch comprising the cyclic oligomer nucleating agent comprises pellets.

16. The polymer composition of claim 1, wherein the neat poly(arylene sulfide) polymer comprises less than about 3,000 ppmw cyclic oligomer nucleating agent, based on the total weight of the neat poly(arylene sulfide) polymer.

17. A process for producing a poly(arylene sulfide) polymer composition comprising:
(a) reacting a sulfur source and a dihaloaromatic compound in the presence of a polar organic compound to form a poly(arylene sulfide) reaction mixture;
(b) washing at least a portion of the poly(arylene sulfide) reaction mixture with a polar organic compound solvent mixture and/or water to obtain a poly(arylene sulfide) polymer composition and a first slurry, wherein the polar organic compound solvent mixture has a temperature of from about 25° C. to about 275° C., and wherein the polar organic compound is present in the polar organic compound solvent mixture in an amount of from about 100 vol. % to about 25 vol. %, based on the total volume of the polar organic compound solvent mixture;
(c) optionally treating at least a portion of the poly(arylene sulfide) polymer composition with an aqueous acid solution and/or an aqueous metal cation solution to obtain a treated poly(arylene sulfide) polymer composition; and
(d) drying at least a portion of the poly(arylene sulfide) polymer composition and/or treated poly(arylene sulfide) polymer composition to obtain a dried poly(arylene sulfide) polymer composition;
wherein the poly(arylene sulfide) polymer composition comprises a poly(arylene sulfide) polymer and a cyclic oligomer nucleating agent; and
wherein the poly(arylene sulfide) polymer composition comprises the cyclic oligomer nucleating agent in an amount of from about 2,500 ppmw to about 13,000 ppmw, based on the total weight of the poly(arylene sulfide) polymer composition.

18. The process of claim 17, wherein the polar organic compound solvent mixture comprises a polar organic compound and water.

19. The process of claim 18, wherein the polar organic compound comprises N-methyl-2-pyrrolidone.

20. A process of producing a poly(arylene sulfide) polymer article comprising:
(i) melting a poly(arylene sulfide) polymer composition to yield a molten poly(arylene sulfide) polymer composition, wherein the poly(arylene sulfide) polymer composition comprises a neat poly(arylene sulfide) polymer and a cyclic oligomer nucleating agent, and wherein the cyclic oligomer nucleating agent is contacted with the neat poly(arylene sulfide) polymer in an amount of from about 0.25 wt. % to about 1 wt. % cyclic oligomer nucleating agent, based on the total weight of the poly(arylene sulfide) polymer composition; and
(ii) injection molding the molten poly(arylene sulfide) polymer composition to yield the poly(arylene sulfide) polymer article, wherein a cycle time of injection molding the poly(arylene sulfide) polymer composition is reduced by at least about 5% when compared to a cycle time of injection molding the neat poly(arylene sulfide) polymer.
